(19) United States
(12) Patent Application Publication
(10) Pub. No.: US 2025/0274551 A1
(43) Pub. Date: Aug. 28, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KEISUKE ITO, Tokyo (JP)

(21) Appl. No.: 19/059,488

(22) Filed: Feb. 21, 2025

(30) Foreign Application Priority Data
Feb. 27, 2024 (JP) 2024-027494
Nov. 27, 2024 (JP) 2024-206728

(51) Int. Cl. H04N 1/00; G06Q 30/0283

(52) U.S. Cl. CPC H04N 1/00344; G06Q 30/0283; H04N 2201/0094

(57) ABSTRACT

An information processing apparatus configured to generate a script for registering information extracted from a document image and corresponding to a predetermined attribute into a cooperation service includes: a generation unit configured to generate a first prompt for generating a script based on a specification for registering the information into the cooperation service; and an output unit configured to output the script for registering the information into the cooperation service based on the script generated by a generative AI in response to input of the first prompt.

### BACKGROUND

### Field

The present disclosure relates to generation of a script for connection to a cooperation service.

### Description of the Related Art

There is a method of extracting information such as a money amount and a date from a document image such as a scanned image obtained by scanning a document with a MFP or the like. Moreover, the information extracted from the document image is sometimes registered into an external cooperation service such as a cloud expenditure adjustment service. The registration of the extracted information into the cooperation service is performed by executing a script in a cooperation source apparatus holding the extracted information.

Japanese Patent Laid-Open No. 2022-129520 proposes a method of a test process in system development.

A script for registering information into a cooperation service varies depending on the cooperation service. Accordingly, a script corresponding to the cooperation service needs to be generated in advance, and work load of generating the script occurs. The method described in Japanese Patent Laid-Open No. 2022-129520 is a method of a test, and cannot reduce the work load of generating the script.

### SUMMARY

An information processing apparatus of the present disclosure is an information processing apparatus configured to generate a script for registering, into a cooperation service, information corresponding to a predetermined attribute and extracted from a document image, and includes: a generation unit configured to generate a first prompt for generating a script based on a specification for registering the information into the cooperation service; and an output unit configured to output the script for registering the information into the cooperation service based on the script generated by a generative AI in response to input of the first prompt.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of the present system;

FIG. 2 is a hardware block diagram of an MFP;

FIG. 3 is a hardware block diagram of an MFP cooperative server and a client PC;

FIG. 4 is a functional block diagram of the present system;

FIG. 5 is a diagram for explaining a key value extraction process;

FIG. 6 is a diagram illustrating an example of a template of a script;

FIG. 7 is a diagram illustrating an example of the script;

FIG. 8 is a sequence diagram illustrating a flow of processes among apparatuses;

FIG. 9 is a flowchart for explaining a script generation process;

FIG. 10 is a diagram illustrating an example of a prompt;

FIG. 11 is a diagram illustrating an example of the prompt;

FIG. 12 is a diagram illustrating an example of a name candidate reply prompt;

FIG. 13 is a diagram illustrating an example of a check screen;

FIG. 14 is a diagram illustrating an example of the prompt;

FIG. 15 is a diagram explaining a conversion example of a name of an attribute in the case where the script is executed;

FIG. 16 is a flowchart explaining a test and a correction process of the script;

FIG. 17 is a diagram illustrating an example of a test code;

FIG. 18 is a diagram illustrating an example of the prompt;

FIG. 19 is a diagram illustrating an example of the prompt;

FIG. 20 is a diagram illustrating an example of a notification screen;

FIG. 21 is a diagram illustrating an example of a template of an additional content generation prompt;

FIG. 22 is a diagram illustrating an example of the additional content generation prompt; and

FIG. 23 is a diagram illustrating an example of the name candidate reply prompt.

### DESCRIPTION OF THE EMBODIMENTS

Embodiments of a technique of the present disclosure are explained below by using the drawings. Note that the following embodiments do not limit the technique of the present disclosure according to the scope of claims. Moreover, not all of combinations of features explained in the following embodiments are necessarily essential for the solving means of the technique of the present disclosure.

### Embodiment 1

### [System Configuration]

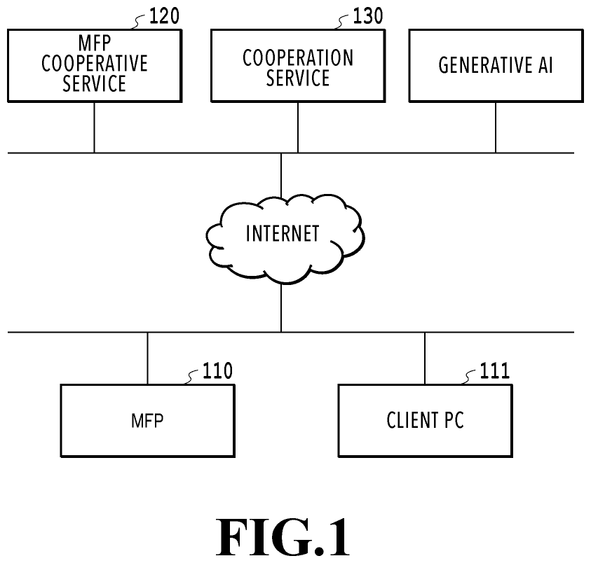

FIG. 1 is a diagram illustrating an overall configuration of an image processing system according to the present embodiment. The image processing system of FIG. 1 includes a multifunction peripheral (MFP) 110, an MFP cooperative service 120, and a client personal computer (PC) 111. The MFP 110 and the client PC 111 are communicably connected to servers that provide various services on the Internet, via a local area network (LAN). Moreover, in the present embodiment, the various services include a cooperation service 130 and a generative AI.

The MFP 110 is a multiple function peripheral with multiple functions such as a scanner and a printer, and is an example of an image forming apparatus.

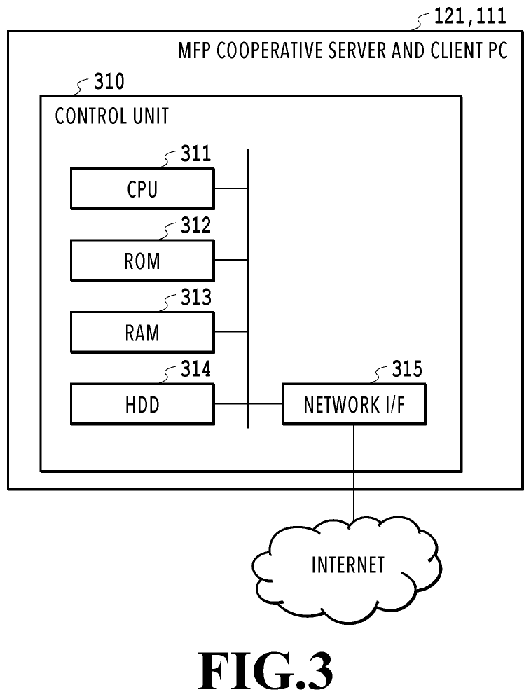

The MFP cooperative service 120 extracts information corresponding to attributes such as a date, a money amount, and the like described in a paper document, from a scanned image obtained by scanning the paper document with the MFP 110, and holds the extracted information. Moreover, the MFP cooperative service 120 is an example of a service of registering the extracted information in the cooperation service 130. A server (information processing apparatus) that provides the MFP cooperative service 120 is referred to as an MFP cooperative server 121 (see FIG. 3).

The cooperation service 130 is, for example, a cloud service that performs processes relating to expenditure adjustment. The cooperation service 130 receives registration of information relating to the expenditure adjustment such as a date and a money amount via the Internet, and performs the processes relating to the expenditure adjustment of the user based on the registered information. Note that the cooperation service 130 is an example of a service (external service) such as an external cloud service that can cooperate with the MFP cooperative service 120, and the MFP cooperative service 120 can cooperate with one or more external services other than the cooperation service 130. In the following explanation, explanation is given assuming that the cooperation service 130 is the only external service that cooperates with the MFP cooperative service 120, for the sake of simplification. The cooperation service 130 may be configured to be provided by a server on the LAN instead of the Internet.

The client PC 111 is an information processing apparatus including an application that requests the MFP cooperative service 120 to perform operations such as generation a script to be described later and execution of a test on the generated script. Note that the configuration of the image processing system is not limited to the configuration illustrated in FIG. 1.

### [Hardware Configuration of MFP]

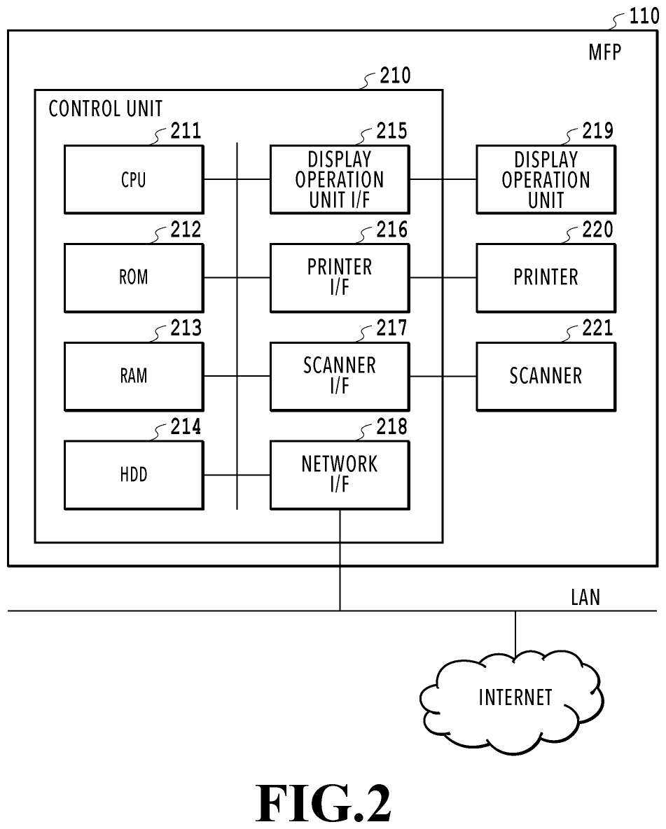

FIG. 2 is a hardware block diagram of the MFP 110. The MFP 110 is formed of a control unit 210, a display operation unit 219, a printer 220, and a scanner 221.

The control unit 210 is formed of the following units 211 to 218, and controls operations of the entire MFP 110. The CPU 211 reads a control program stored in the ROM 212, and executes and controls various functions of the MFP 110 such as reading, printing, and communication. The RAM 213 is used as a temporary storage area such as a main memory or a work area of the CPU 211. Note that, although one CPU 211 is assumed to execute processes illustrated in the flowchart to be described later by using one memory (RAM 213 or HDD 214) in the present embodiment, the present disclosure is not limited to this. For example, multiple CPUs and multiple RAMs or HDDs may work in cooperation to execute the processes. The HDD 214 is a high-capacity storage unit that stores image data and various programs.

The display operation unit I/F 215 is an interface that connects the display operation unit 219 and the control unit 210 to each other. The display operation unit 219 includes a touch panel that functions as a display unit and an operation unit, a keyboard that is the operation unit, and the like, and receives operations, inputs, and instructions made by the user.

The printer I/F 216 is an interface that connects the printer 220 and the control unit 210 to each other. Image data for printing is transferred from the control unit 210 to the printer 220 via the printer I/F 216, and is printed on a print medium such as a paper sheet.

The scanner I/F 217 is an interface that connects the scanner 221 and the control unit 210 to each other. The scanner 221 generates a scanned image by optically reading a paper document set on a not-illustrated platen glass or auto-document feeder (ADF), and inputs the scanned image into the control unit 210 via the scanner I/F 217. The scanned image can be printed (copied and outputted) by the printer 220, transmitted to the MFP cooperative service 120 via the LAN, or transmitted by e-mail.

The network I/F 218 is an interface that connects the control unit 210 of the MFP 110 to the LAN. The MFP 110 can transmit the scanned image and information to each of services on the Internet and receive various pieces of information by using the network I/F 218. The hardware configurations of the MFP 110 explained above are examples, and may include other configurations or may not include some of the configurations as necessary.

[Hardware Configurations of MFP cooperative server and Client PC]

FIG. 3 is a hardware block diagram of a control unit of the client PC 111 and the MFP cooperative server 121 that provides the MFP cooperative service 120. The control unit 310 of the client PC 111 and the MFP cooperative server 121 includes a CPU 311, a ROM 312, a RAM 313, an HDD 314, and a network I/F 315. The CPU 311 controls operations of the entire apparatus by reading a control program stored in the ROM 312 and executing various processes. The RAM 313 is used as a temporary storage area such as a main memory and a work area of the CPU 311. The HDD 314 is a high-capacity storage unit that stores image data and various programs. The network I/F 315 is an interface that connects the control unit 310 to the Internet. The MFP cooperative server 121 (MFP cooperative service 120) receives processing requests from other apparatuses such as the MFP 110 via the network I/F 315, and exchanges various pieces of information with the other apparatuses.

### [Functional Framework of MFP]

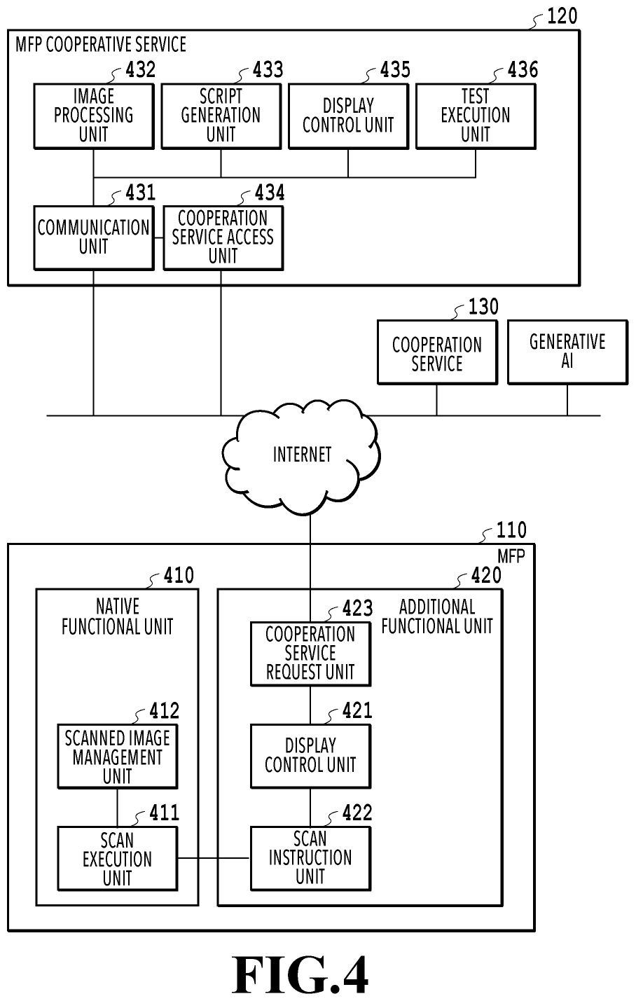

FIG. 4 is a diagram illustrating a functional framework of an image processing system according to the present embodiment. Functional frameworks corresponding to a role of each of the MFP 110 and the MFP cooperative service 120 forming the image processing system are explained one by one. Note that the functional frameworks are explained while focusing on functions relating to processes from a point where a document is scanned and computerized (filed) to a point where information is registered in the cooperation service 130, among various functions of the apparatuses.

The MFP 110 includes two functional units of a native functional unit 410 and an additional functional unit 420. The native functional unit 410 is a functional unit included in the MFP 110 as a standard, while the additional functional unit 420 is a functional unit implemented by an application additionally installed into the MFP 110. The additional functional unit 420 is, for example, an application based on Java (registered trademark), and addition of a function to the MFP 110 is easily implemented. Note that not-illustrated other additional applications may be installed in the MFP 110.

The native functional unit 410 includes a scan execution unit 411 and a scanned image management unit 412. The additional functional unit 420 includes a display control unit 421, a scan instruction unit 422, and a cooperation service request unit 423.

The display control unit 421 displays UI screens for receiving operations made by the user, on a display unit having a touch panel function in the display operation unit 219 of the MFP 110. The display control unit 421 displays UI screens such as a screen in which authentication information for access to the MFP cooperative service 120 is inputted, a scan setting screen, a scan start screen, a preview display screen of the scanned image, and a screen for setting a file name and a folder path of file save destination.

The scan instruction unit 422 requests the scan execution unit 411 to execute scan setting and a scan process in response to user operations inputted via the UI screens.

The scan execution unit 411 obtains a scan request including the scan setting from the scan instruction unit 422. The scan execution unit 411 causes the scanner 221 to execute an operation of reading the document via the scanner I/F 217, and generates the scanned image of the document according to the obtained scan request. The scan execution unit 411 sends the generated scanned image and a scanned image identifier uniquely indicating this scanned image, to the scanned image management unit 412. The scanned image identifier is a number, a symbol, an alphabet, or the like for uniquely identifying the scanned image in the MFP 110.

The scanned image management unit 412 saves scanned image data received from the scan execution unit 411, in the HDD 214.

The scan instruction unit 422 can obtain the scanned image to be requested to be processed by the MFP cooperative service 120, from the scanned image management unit 412 by using the scanned image identifier. The scan instruction unit 422 requests the cooperation service request unit 423 to give an instruction to perform processing on the obtained scanned image in the MFP cooperative service 120.

The cooperation service request unit 423 requests the MFP cooperative service 120 to perform various processes. For example, the cooperation service request unit 423 requests the MFP cooperative service 120 to perform a log-in process or a process of extracting information from the scanned image. Moreover, the cooperation service request unit 423 requests the MFP cooperative service 120 to register the information extracted from the scanned image in the cooperation service 130. Although the cooperation service request unit 423 executes communication with the MFP cooperative service 120 by using a protocol such as REST or SOAP, other communication means may be used.

The CPU 211 implements the functional units of the MFP 110 by loading a program stored in the ROM 212 or the HDD 214 of the MFP 110 onto the RAM 213 and executing the program. Alternatively, part or all of the functions may be implemented by hardware such as an ASIC or an electronic circuit.

### [Functional Configuration of MFP Cooperative Service]

The MFP cooperative service 120 includes a communication unit 431, an image processing unit 432, a script generation unit 433, a cooperation service access unit 434, a display control unit 435, and a test execution unit 436.

The communication unit 431 receives a request of a process from an external apparatus, and instructs the image processing unit 432, the script generation unit 433, the cooperation service access unit 434, the display control unit 435, and the test execution unit 436 to perform processes depending on the process indicated in the received request. For example, the communication unit 431 performs control such that the log-in process is performed in response to a log-in request from the MFP 110.

The image processing unit 432 performs image processes such as a process of detecting a character area, a character recognition process, and a key value extraction process on a document image such as the scanned image transmitted from the MFP 110. Details of the key value extraction process are described later. The character recognition process is also referred to as optical character recognition process or OCR process.

The cooperation service access unit 434 performs processes such as a process of registering information in the cooperation service 130. Specifically, the cooperation service access unit 434 executes a script for registering information in the cooperation service 130 to register the information by calling an API made publicly available by the cooperation service 130. In the present embodiment, a script outputted by the script generation unit 433 to be described later is used as the script.

The display control unit 435 receives a request from a web browser operating on the client PC 111 or the like connected via the Internet, and transmits screen configuration information (HTML, CSS, or the like) necessary for screen display, to the client PC 111. The user can give instructions such as an instruction to check a test result through a screen displayed on the web browser.

The script generation unit 433 performs a process of causing a generative AI to generate the script to be executed by the cooperation service access unit 434.

Specifically, a template of the script is prepared in advance, and the script generation unit 433 generates a prompt instructing filling of the template of the script. The script generation unit 433 inputs the generated prompt into the generative AI, and causes the generative AI to generate the script. Examples of the generative AI include ChatGPT (https://chat.openai.com/), GitHub Copilot (https://github.com/features/copilot/), and the like. Alternatively, the configuration may be such that a trained learning model that outputs the script is prepared, and the script generation unit 433 generates the script by using this trained model. In the present embodiment, the generative AI used by the script generation unit 433 is assumed to be a generative AI trained by using various scripts such as GitHub Copilot. Such a generative AI outputs a script according to a natural language context of the inputted prompt.

The script generation unit 433 has functions of a prompt generation unit configured to generate the prompt to be inputted into the generative AI and an output unit configured to output the script to the cooperation service access unit 434. The script generation unit 433 may output the generated script to an external apparatus.

The test execution unit 436 functions as a test unit configured to perform a test of checking whether the script generated by the script generation unit 433 properly operates or not and a correction unit configured to correct the script determined not to operate properly. Details are described later.

The CPU 311 implements the functional units of the MFP cooperative service 120 by loading a program stored in the ROM 312 or the HDD 314 of the MFP cooperative server 121 onto the RAM 313 and executing the program. Part or all of the functions of the MFP cooperative service 120 may be implemented by hardware such as an ASIC or an electronic circuit.

The information processing apparatus such as the MFP 110 or the client PC 111 may include at least part of the above-mentioned functions of the MFP cooperative service 120. For example, the MFP 110 may have the functions of the MFP cooperative service 120. Moreover, the client PC 111 may include the script generation unit 433 and the test execution unit 436, and output the generated script to the MFP cooperative service 120 holding the information to be registered into the cooperation service.

### [Regarding Key Value Extraction]

The key value extraction performed by the image processing unit 432 is explained. The key value extraction is a process of extracting a character string (value) corresponding to each attribute from the document image. Explanation is given assuming that the document image in the present embodiment is the scanned image obtained by scanning a paper document. Alternatively, the document image may be PDF, JPEG, or the like generated by using a document creation application operating on a PC.

A key is a character string that may be adjacent to the value. For example, in the key value extraction, a key of an attribute desired to be extracted is found from a character string group obtained by performing the OCR process on the document image to be processed, and a character string adjacent to this key is extracted as the value.

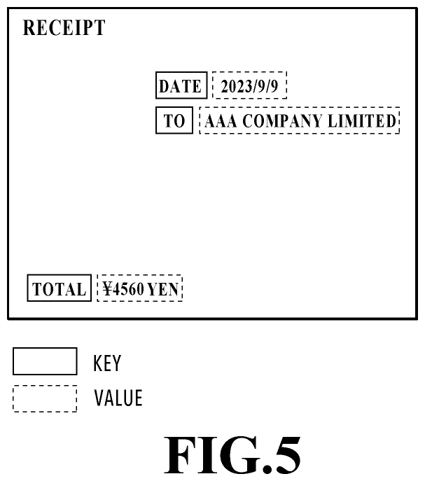

FIG. 5 is a diagram illustrating an example of the document image that is the target of the key value extraction process. The key value extraction executed by the image processing unit 432 is explained by using FIG. 5. The attributes of the values to be extracted in the key value extraction process are assumed to be date information, destination information, and money amount information. In this case, regarding the date information, a character string “date” is detected as the key from among character strings recognized from FIG. 5. Then, a character string “2023 Sep. 9” adjacent to the character string “date” that is the detected key is extracted as the value corresponding to the date information. Regarding the destination information, a character string “To” is detected as the key from among the character strings recognized from FIG. 5, and a character string “AAA Company Limited” adjacent to the character string “To” that is the key is extracted as the value corresponding to the destination information. Regarding the money amount information, a character string “total” is detected as the key from among the character strings recognized from FIG. 5, and a character string “¥4560 yen” adjacent to the character string “total” that is the key is extracted as the value corresponding to the money amount information.

Moreover, it is assumed that, in the key value extraction performed by the image processing unit 432 of the MFP cooperative service 120, the names of the attributes to be extracted are fixed, the name of the date information is registered as “date”, the name of the destination information is registered as “destination”, and the name of the money amount information is registered as “money amount”. These names of the attributes are assumed to be expressed as names of “attribute of information extracted by MFP cooperative service”. Accordingly, for example, the value of the date information extracted in the MFP cooperative service 120 is stored in association with the name “date” of the attribute of the MFP cooperative service 120.

### [Regarding Script]

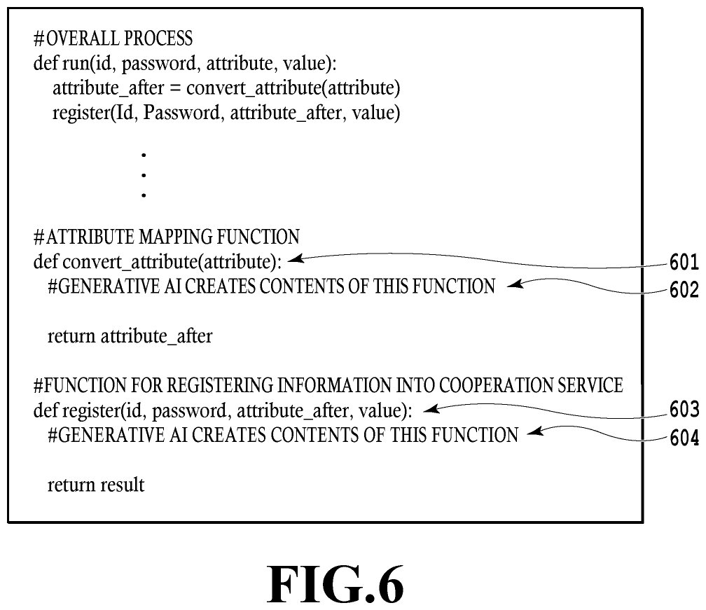

FIG. 6 is a diagram illustrating an example of the template of the script. In the present embodiment, the script generation unit 433 is assumed to generate a script to be executed in the case where information is registered into an external service such as the cooperation service 130, based on the template of FIG. 6. Explanation is given assuming that the information registered in the present embodiment is the character strings (values) extracted by the key value extraction.

In the template of the script in FIG. 6, there are described definition portions of functions to be called in the registration of the information into the external service and implementation portions indicating process contents of the functions. Note that, for some of the functions included in the template, only the definition portions of the functions are described, and details of the implementation portions are not described. In FIG. 6, a convert_attribute function and a register function correspond to the functions whose definition portions 601 and 603 are described but whose implementation portions 602 and 604 are not described. The implementation portions 602 and 604 of these functions vary depending on the external service that is the registration destination of the information, and are thus in a not-described state in the template.

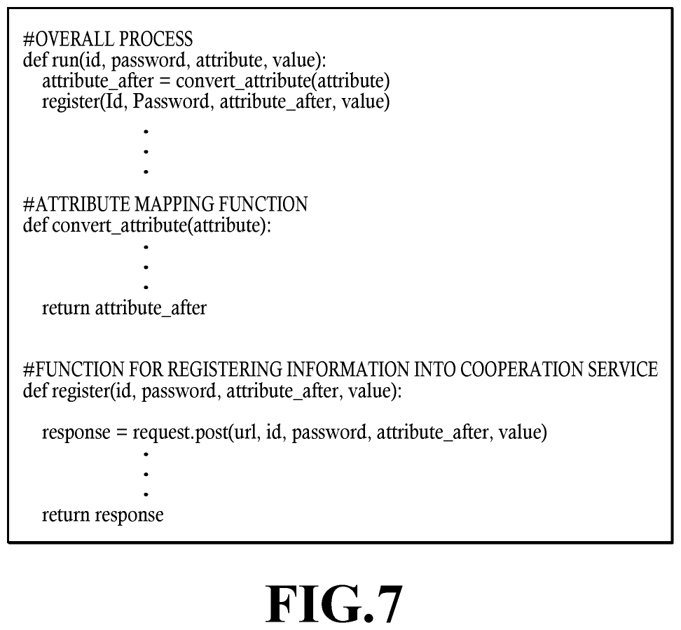

FIG. 7 is a diagram illustrating an example of a script generated by the script generation unit 433 based on the template of FIG. 6. The script of FIG. 7 is an example of the script for registering the values in the cooperation service 130. Accordingly, FIG. 7 is a script in which the implementation portions 602 and 604 of the convert_attribute function and the register function in the template of FIG. 6 are described to allow registration of the information into the cooperation service 130.

In the case where the script of FIG. 7 is executed, first, a run function is called, and the convert_attribute function and the register function are subsequently called during this operation. The convert_attribute function is a function that converts the names of the attributes of the information extracted by the MFP cooperative service to allow registration of the names into the cooperation service 130. The register function is a function that registers information into the external service such as the cooperation service 130. Details of each function are described later.

### [Flow of Overall Process]

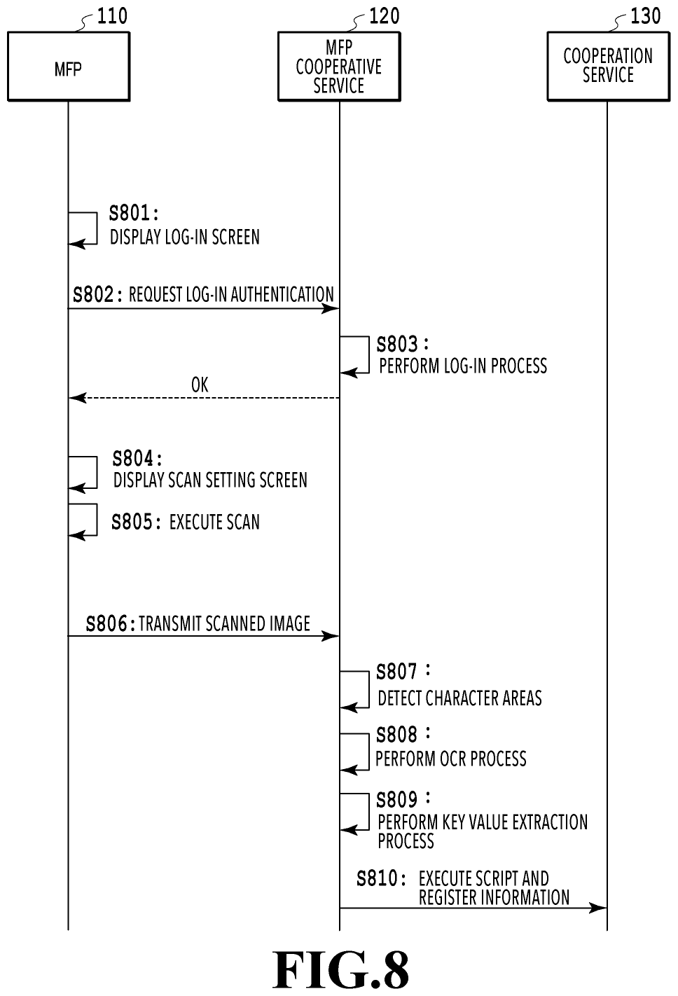

FIG. 8 is a sequence diagram illustrating a flow of processes among the apparatuses (services) from a point where information on the date, the money amount, and the like described in the document is extracted from the scanned image obtained by scanning the document to a point where the information is registered. Note that the symbol “S” in the following expression is assumed to express step.

In the case where the MFP 110 is in a normal state, a main screen in which buttons that allow the user to select the respective applications provided by the MFP 110 are arranged side by side is displayed on the touch panel of the MFP 110. The user installs an application (hereinafter, referred to as scan application) that extracts the information on the date, the money amount, and the like described in the document and registers the information into the external service, and a button for using the scan application is thereby displayed on the main screen. In the case where the user presses the button of the scan application on the main screen, the processes illustrated in the sequence of FIG. 8 are performed.

In S801, the MFP 110 displays a log-in screen in which authentication information (ID and password) for accessing the MFP cooperative service 120 is inputted, on the touch panel. In the case where the user inputs the user ID and the password into input fields in the log-in screen and presses a “log-in” button, a request of log-in authentication is transmitted to the MFP cooperative service 120.

In S802, the MFP 110 requests log-in to the MFP cooperative service 120 based on the authentication information inputted through the log-in screen.

In S803, the MFP cooperative service 120 verifies whether the ID and the password included in the log-in request are correct. In the case where the ID and the password are correct, the MFP cooperative service 120 sends back an access token to the MFP 110. In various requests made from the MFP 110 to the MFP cooperative service 120 from here onwards, demands are transmitted together with this access token. The MFP cooperative service 120 can identify the user being the processing target based on the access token. The user authentication method is performed by using a generally and publicly known method (authorization using Basic authentication, Digest authentication, OAuth, or the like).

In S804, in the case where the log-in process is completed, the MFP 110 displays a scan setting screen.

In S805, the MFP 110 performs various types of setting relating to scanning of the document by the scanner 221 based on contents instructed by the user through the scan setting screen. In the case where the user presses a “scan start” button on the scan setting screen, the scanner 221 executes scanning on the paper document to be scanned that is placed on the platen glass or the ADF. Then, the scan execution unit 411 generates data of the scanned image obtained by reading the scanned paper document.

In S806, the MFP 110 transmits the scanned image generated by the scan process of S805 to the MFP cooperative service 120. In the case where the MFP cooperative service 120 receives the scanned image, image processes of S807 to S809 are started in the image processing unit 432 of the MFP cooperative service 120.

In S807, the MFP cooperative service 120 analyzes a pattern of pixel values in the scanned image, and detects character areas that are areas in which characters are written in the scanned image.

In S808, the MFP cooperative service 120 performs the OCR process of recognizing characters and converting the characters to text data, on the detected character areas.

In S809, the MFP cooperative service 120 performs the above-mentioned key value extraction process on the text data obtained as a result of S808. As a result, values that are described in the document illustrated in the scanned image and that correspond to the respective attributes of date, destination, and money amount are extracted.

In S810, the MFP cooperative service 120 registers the values extracted in S809 and corresponding to the attributes of date, address, and money amount, into the cooperation service 130. A script exclusive to the cooperation service 130 is executed to access the cooperation service 130 and register necessary information. Specifically, in S810, the script of FIG. 7 outputted by the script generation unit 433 to register the information into the cooperation service 130 is executed, and the values are registered.

### [Script Generation Process]

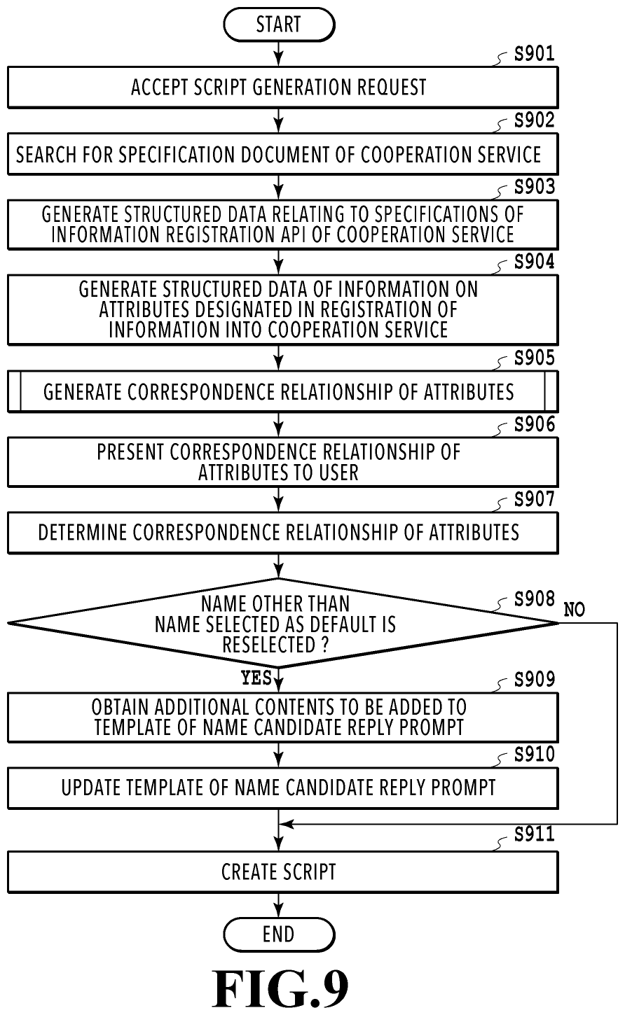

FIG. 9 is a flowchart illustrating a flow of a process of generating the script to be executed in S810 by using the generative AI. The CPU 311 executes the process of the flowchart of FIG. 9 by developing a program code stored in the HDD 314 of the MFP cooperative server 121 on the RAM 313. Moreover, part or all of functions in steps of FIG. 9 may be implemented by hardware such as an ASIC or an electronic circuit.

The flowchart of FIG. 9 is started, for example, in the case where the user requests the script generation unit 433 to generate the script for the external service that is the script generation target, from the client PC 111 at any timing before start of the sequence of FIG. 8. In the present embodiment, the steps of FIG. 9 are explained assuming that the cooperation service 130 is designated as the external service in the script generation request. In the case where a script for another external service is to be generated, there is performed a process in which the cooperation service 130 in the explanation of the steps of FIG. 9 is replaced by this other external service.

In S901, the communication unit 431 accepts the script generation request sent from the client PC 111 via the Internet. In the script generation request, at least the cooperation service 130 that is the script generation target of this operation is designated.

In S902, the script generation unit 433 searches specification documents of the external services saved in the HDD 314, for a text (specification document) that includes specifications for registering information into the cooperation service 130 designated in the script generation request accepted in S901. The specifications for registering information includes a specification of an information registration API. In the case where the attributes are designated as in the present embodiment, the specifications for registering information also include information on the attributes to be registered. In the present embodiment, the specifications of the information registration API are assumed to include a function to be called as the API (name of API), an argument of this function, a return value of this function, explanation of this function, data type of the argument and the return value of this function, and explanation of the argument and the return value of this function. The specifications of the information registration API are examples, and the present disclosure is not limited to these specifications as long as the specifications are specifications for generating the script.

In the present embodiment, the specification documents of the respective external services are saved in the HDD 314, and a vectorization process in which similar contents are made to have similar vectors is performed on each of the specification documents. The vectorized specification documents are stored in advance in a vector database in the HDD 314. Note that a specification document in which no specifications for registering information are described is also saved in the HDD 314 in some cases.

Moreover, “which specification document is specification document describing specifications for registering information into ‘name of cooperation service’?” is prepared in advance as a template of a search query character string. The portion of “name of cooperation service” in this template is replaced by the name of the cooperation service 130 designated in the script generation request accepted in S901. In the present embodiment, the “name of cooperation service” is replaced by “XXX service” that is the name of the cooperation service 130, and the search query character string is thereby generated. Then, the vectorizing process is similarly performed on a search query character string of “which specification document is specification document describing specifications for registering information into XXX service?” Next, the script generation unit 433 calculates a degree of vector similarly between the vectorized search query character string and each of the vectorized specification documents saved in the vector database. Then, the script generation unit 433 extracts a specification document with a high degree of vector similarity with the search query character string as the specification document including the specifications for registering information into the cooperation service 130.

In S903, the script generation unit 433 generates structured data in which the specifications of the information registration API of the cooperation service 130 are organized, by using the generative AI. A specific process of S903 is as follows. First, the script generation unit 433 generates a prompt including an instruction for generating structured data in which the specifications of the information registration API of the cooperation service 130 are organized depending on an item, by referring to the specification document obtained in S902.

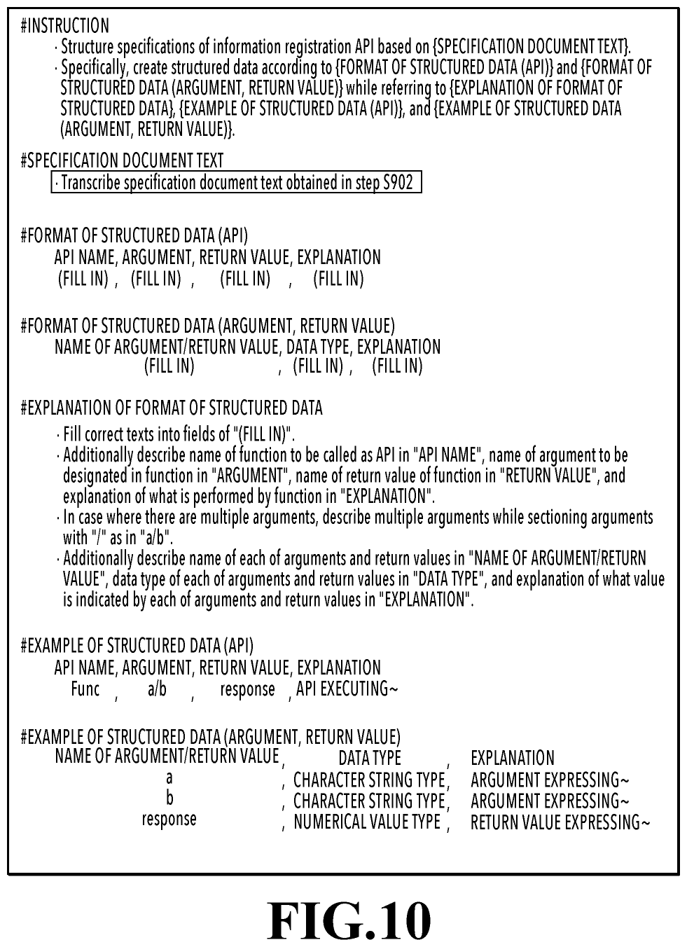

FIG. 10 is a diagram illustrating an example of a prompt that causes the generative AI to generate the structured data in which the specifications of the information registration API are organized. In the prompt, there are described “specification document text”, “format of structured data”, “explanation of format of structured data”, and “example of structured data”, in addition to “instruction”. These items are examples of items for causing the generative AI to give a reply, and not all of the items are essential items.

A template for generating the prompt of FIG. 10 is generated in advance and stored in the HDD 314. The template corresponding to the prompt of FIG. 10 is a template in a state where a text in the specification document is not transcribed to a field of “#specification document text” in the prompt of FIG. 10. The script generation unit 433 obtains the template corresponding to the prompt of FIG. 10, transcribes the entire specification document obtained in S902 to the field of “#specification document text” in the obtained template, and generates the prompt of FIG. 10.

Table 1 and Table 2 are tables expressing, in a table format, examples of the structured data in which the specifications of the information registration API are organized. The script generation unit 433 inputs the prompt of FIG. 10 into the generative AI, and obtains the structured data as illustrated in Table 1 and Table 2 from a reply outputted from the generative AI.

The generative AI describes the function to be called as the API in the column of “API name” in Table 1. The generative AI describes the names of the arguments to be designated in the function to be called as the API, in the column of “argument”. Moreover, the generative AI describes the name of the return value of the function to be called as the API, in the column of “return value”, and describes explanation of what is performed by the function to be called as the API, in the column of “explanation”.

TABLE 1

| API name | Argument | Return value | Explanation |
|---|---|---|---|
| requests.post | url/id/password/attribute/value | response | Information |
| | | | registration API |

The generative AI describes the name of each of the arguments and the return values of the function to be called as the API in the column of “name of argument/return value” in Table 2. The generative AI describes the data type of each of the arguments and the return values of the function to be called as the API in the column of “data type”, and describes explanation of what value is indicated by each of the arguments and the return values of the function to be called as the API, in the column of “explanation”. In Table 2, in the case where a variable indicating that data is formed of multiple elements such as “characters string arrangement type” or “list type” is held in the column of “data type”, i-th elements are assumed to be linked to each other, assuming that the number of elements from the head is i. In the example of Table 2, the argument attribute [i] and the value [i] are linked to each other.

TABLE 2

| Name of argument/return | | |
|---|---|---|
| value | Data type | Explanation |
| url | Character string type | Connection destination |
| | | URL |
| id | Character string type | User ID |
| password | Character string type | Password |
| attribute | Character string | Attribute. i-th attribute is |
| | arrangement type | linked to i-th value |
| value | List type | Value. i-th value is |
| | | linked to i-th attribute |
| response | Numerical value type | Processing result |

Among information registration APIs, there is an API that also receives designation of the attribute and the value in the information registration. Table 1 and Table 2 are examples of the structured data outputted as a result of inputting a prompt into the generative AI, the prompt generated by transcribing, to FIG. 10, the specification document of the external service provided with the information registration API as described above.

Moreover, there is an external service in which an API is provided for each of the attributes of the values to be registered, as the information registration API. Table 3 and Table 4 are examples of the structured data outputted as a result of inputting, into the generative AI, the prompt of FIG. 10 to which the specification document of an external service is transcribed, the external service being a service provided with the information registration APIs as described above.

Table 3 is the structured data corresponding to Table 1, and Table 4 is the structured data corresponding to Table 2. Table 3 indicates that an API is provided for each of three attributes, unlike in Table 1. As described above, there are various types of information registration API. However, in the present embodiment, the generative AI is made to generate the structured data in which the specifications of the information registration API are organized based on the specification document of the target external service. Accordingly, appropriate information on the information registration API can be appropriately obtained.

TABLE 3

| | | Return | |
|---|---|---|---|
| API name | Argument | value | Explanation |
| register_date_of_payment | url/id/password/date_of_payment | response | Information |
| | | | registration |
| | | | API (for |
| | | | date of |
| | | | payment) |
| register_address | url/id/password/address | response | Information |
| | | | registration |
| | | | API (for |
| | | | destination |
| | | | company |
| | | | name) |
| register_total_amount | url/id/password/total_amount | response | Information |
| | | | registration |
| | | | API (for |
| | | | total money |
| | | | amount) |

TABLE 4

| Name of argument/return | | |
|---|---|---|
| value | Data type | Explanation |
| url | Character string type | Connection destination |
| | | URL |
| id | Character string type | User ID |
| password | Character string type | Password |
| date_of_payment | Character string type | Value (date of payment) |
| address | Character string type | Value (destination |
| | | company name) |
| total_amount | Numerical value type | Value (total money |
| | | amount) |
| response | Numerical value type | Processing result |

In S904, the script generation unit 433 uses the generative AI to generate the structured data of the information on the attributes designated in the registration of information into the cooperation service 130. Attributes that can be designated in the cooperation service 130 in the registration of information into the cooperation service 130 are expressed as “attribute of information to be registered into cooperation service”. As a specific process, first, the script generation unit 433 generates a prompt including an instruction for generating the structured data in which the information on the “attribute of information to be registered into cooperation service” is organized, by referring to the specification document obtained in S902.

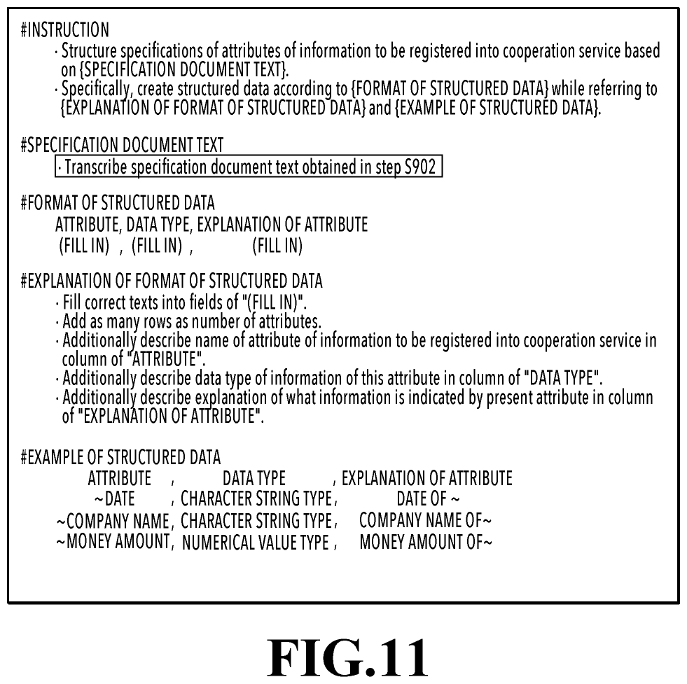

FIG. 11 is a diagram illustrating an example of the prompt generated in S904. In the prompt, there are described, “specification document text”, “format of structured data”, “explanation of format of structured data”, and “example of structured data”, in addition to “instruction”. These items are examples of items for causing the generative AI to give a reply, and not all of the items are essential items.

A template for generating the prompt of FIG. 11 is generated in advance and stored in the HDD 314. The script generation unit 433 transcribes the specification document obtained in S902 to the template corresponding to the prompt of FIG. 11, and generates the prompt of FIG. 11.

Table 5 is a table expressing, in a table format, an example of the structured data in which the information on the attributes of the information to be registered into the cooperation service 130 is organized. The script generation unit 433 inputs the prompt of FIG. 11 into the generative AI, and obtains the structured data as illustrated in Table 5 from the reply outputted from the generative AI. The generative AI describes the names of the “attribute of information to be registered into cooperation service” in the column of “attribute” in Table 5. Moreover, the generative AI describes the data type of the value corresponding to each attribute in the column of “data type”, and describes explanation of what information is indicated by each attribute, in the column of “explanation of attribute”.

TABLE 5

| Attribute | Data type | Explanation of attribute |
|---|---|---|
| “Date of payment” | Character string type | Date at which payment is |
| | | generated |
| “Date of creation” | Character string type | Date of creation of |
| | | business form |
| “Destination company | Character string type | Company name of |
| name” | | business form destination |
| “Issuer company name” | Character string type | Company name of |
| | | business form issuer |
| “Money amount excluding | Numerical value type | Total money amount |
| tax” | | (excluding tax) |
| “Total money amount” | Numerical value type | Total amount |

Note that S903 and S904 may be performed as one step. For example, the configuration may be such that a prompt obtained by combining the prompts of FIGS. 10 and 11 is generated and the generative AI is made to output Tables 1, 2, and 5 (or Tables 3, 4, and 5).

In S905, the script generation unit 433 obtains name candidates of the attributes of information to be registered into the cooperation service that correspond, respectively, to the names of the attributes of information extracted by the MFP cooperative service by using the generative AI.

A specific process of S905 is explained. First, the script generation unit 433 generates a prompt (referred to as “name candidate reply prompt”) for causing the generative AI to reply the name candidates of the “attribute of information to be registered into cooperation service” corresponding to the “attribute of information extracted by MFP cooperative service”.

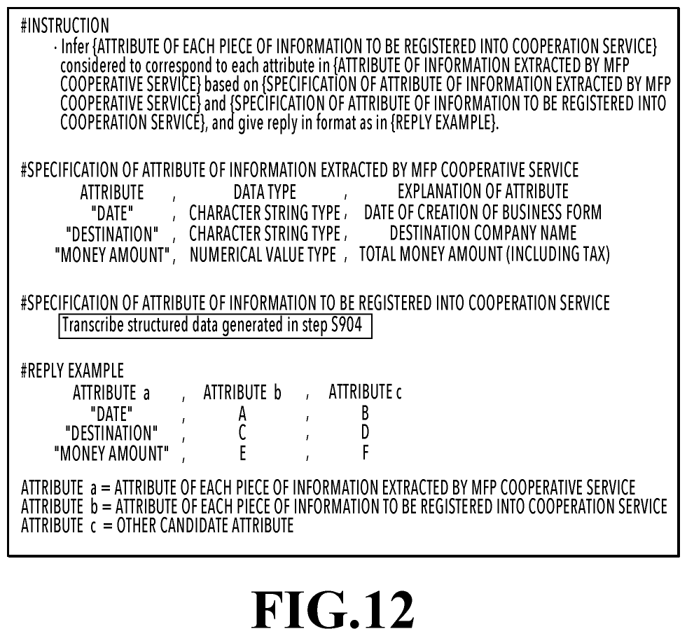

FIG. 12 is a diagram illustrating an example of the name candidate reply prompt generated in S905. In the name candidate reply prompt of FIG. 12, there are described “specification of attribute of information extracted by MFP cooperative service”, “specification of attribute of information to be registered into cooperation service”, and “reply examples”, in addition to “instruction”. These items are examples of items for causing the generative AI to give a reply, and not all of the items are essential items.

A template (referred to as “template of the name candidate reply prompt”) for generating the name candidate reply prompt of FIG. 12 is generated in advance and stored in the HDD 314. The script generation unit 433 obtains the template of the name candidate reply prompt. Then, the script generation unit 433 transcribes Table 5 obtained as a result of S904 to a field of “#specification of attribute of information to be registered into cooperation service” in the obtained template of the name candidate reply prompt. As a result, the name candidate reply prompt as illustrated in FIG. 12 is generated.

The specifications of the attributes used in the MFP cooperative service 120 are described in the field of “#specification of attribute of information extracted by MFP cooperative service” in the name candidate reply prompt of FIG. 12. The contents in the field of “#specification of attribute of information extracted by MFP cooperative service” are described in advance in the template as illustrated in FIG. 12. In the case where the attributes of the extraction targets of the key value extraction process in the MFP cooperative service 120 are changed, the contents in the field of “#specification of attribute of information extracted by MFP cooperative service” in the name candidate reply prompt are also updated. The information in the field of “#specification of attribute of information extracted by MFP cooperative service” may be such that the latest specifications relating to the attributes of the information to be extracted by the MFP cooperative service are obtained by making an inquiry to the MFP cooperative service about the latest specifications and are transcribed in the generation of the name candidate reply prompt.

An “#reply example” includes an instruction that causes the generative AI to reply multiple name candidates of the attribute in the cooperation service corresponding to the name of the attribute of each piece of information extracted by the MFP coordinate service. Moreover, the “#reply example” includes an instruction that causes the generative AI to reply the most-probable candidate among the multiple candidates. In FIG. 12, an “attribute of each piece of information to be registered in coordinate destination service” correspond to the instruction that causes the generative AI to reply the most-probable candidate.

Table 6 is a table expressing, in a table format, examples of the name candidates of “attribute of information to be registered into cooperation service” corresponding to the respective names of “attribute of information extracted by MFP cooperative service”. Table 6 is an example of the structured data replied by the generative AI in response to inputting of the name candidate reply prompt of FIG. 12 into the generative AI.

The names held in the column of “attribute of each piece of information to be registered into cooperation service” and the column of “other candidate attribute” are the name candidates of the attributes of information to be registered into the cooperation service 130 that are replied by the generative AI. Each of the names held in the column of “attribute of each piece of information to be registered into cooperation service” is a candidate determined by the generative AI as the most-probable candidate among the name candidates of the attribute of information to be registered into the cooperation service. Each of the names held in the column of “other candidate attribute” is a candidate that has the possibility of being the name of the attribute of a corresponding piece of information to be registered into the cooperation service other than the candidate held in the column of “attribute of each piece of information to be registered in the cooperative destination service”.

TABLE 6

| | Attribute of each piece of | |
|---|---|---|
| Attribute of each piece of | information to be | |
| information extracted by | registered into cooperation | |
| MFP cooperative service | service | Other candidate attribute |
| “Date” | “Date of creation “ | “Date of payment” |
| “Destination” | “Destination company | “Issuer company name” |
| | name” | |
| “Money amount” | “Total money amount” | “Money amount excluding |
| | | tax” |

In S906, the display control unit 435 performs a process of presenting a processing result of S905 to the user. Specifically, the display control unit 435 performs a process of presenting the contents of Table 6 obtained as a result of S905 to the user.

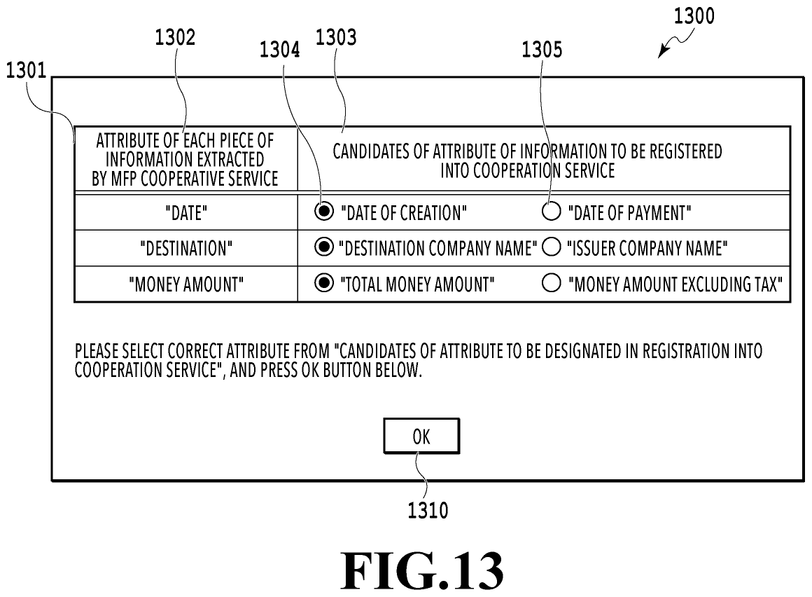

FIG. 13 is a diagram illustrating an example of a check screen that is a screen configured to present the processing result of S905 to the user. The display control unit 435 transmits screen configuration information necessary for display of the check screen 1300 illustrated in FIG. 13 to the client PC 111. The client PC 111 displays the check screen 1300 illustrated in FIG. 13 on the display unit of the client PC 111 based on the received screen configuration information.

The check screen 1300 includes a table 1301 expressing the contents of Table 6. In a column 1303 of the table 1301, the character string held in the column of “attribute of each piece of information to be registered into cooperation service” in Table 6 and the character string held in the column of “other candidate attribute” in Table 6 are displayed as two candidates. Moreover, two radio buttons 1304 and 1305 that allow the user to select one of these two candidates are provided in the column 1303 of FIG. 13. Accordingly, the check screen 1300 has a screen configuration in which the user can select an appropriate candidate out of the two name candidates of the attributes of information to be registered into the cooperation service.

The display control unit 435 controls the display of the check screen 1300 such that the check screen 1300 is displayed in a state where the radio buttons corresponding to the names held in the column of “attribute of each piece of information to be registered into cooperation service” in Table 6 are selected as a default. Specifically, the display control unit 435 transmits the screen configuration information to the client PC 111 such that the check screen 1300 is displayed in a state where the radio buttons 1304 are selected as illustrated in FIG. 13. Since the name candidate reply prompt illustrated in FIG. 12 includes the instruction that causes the generative AI to reply the “attribute of each piece of information to be registered into cooperation service” that is the candidate to be set to the selected state as a default, the check screen 1300 can be controlled as illustrated in FIG. 13. Selecting the names of the attributes determined to be the most-probable candidates by the generative AI as a default in advance in the check screen 1300 can reduce work of the user pressing another radio button and changing the selection state to the correct name.

The user selects the radio button of the appropriate candidate out of the radio buttons 1304 and 1305 for each attribute in the check screen 1300 of FIG. 13, and presses an OK button 1310. The client PC 111 transmits the contents of the appropriate candidates selected by the user by pressing the radio buttons in the check screen 1300 of FIG. 13, to the MFP cooperative service 120. The name candidates of “attribute of information to be registered into cooperation service” are presented to the user as illustrated in FIG. 13 because there is a possibility that the name candidates of the attributes replied by the generative AI in S905 are erroneous. Moreover, in the case where the generative AI replies an erroneous name candidate of the attribute in S905, this error is not detected in the test to be described later in the present embodiment.

In S907, the script generation unit 433 obtains the name candidates of the attributes selected by the user in S906. Then, the names of the “attribute of information to be registered into cooperation service” corresponding to the respective names of the “attribute of information extracted by MFP cooperative service” are determined. For example, in the case where the OK button 1310 is pressed in the state of the check screen 1300 in FIG. 13, in S906, data indicating that the name of the “attribute of information to be registered into the cooperation service” corresponding to the “date” is “date of creation” is transmitted to the MFP cooperative service 120. Similarly, data indicating that the name of the attribute corresponding to the “destination” is “destination company name” and the name of the attribute corresponding to the “money amount” is “total money amount” is transmitted to the MFP cooperative service 120. In S907, the transmitted data is received, and the structured data as illustrated in Table 7 in which the names of the “attribute of information to be registered into cooperation service” corresponding to the respective names of the “attribute of information extracted by MFP cooperative service” are associated with the names of the “attribute of information to be registered into cooperation service” is generated, and the names of the attributes are thereby determined.

TABLE 7

| Attribute of each piece of information | Attribute of each piece of information to |
|---|---|
| extracted by MFP cooperative service | be registered into cooperation service |
| “Date” | “Date of creation” |
| “Destination” | “Destination company name” |
| “Money amount” | “Total money amount” |

Note that, in the case where the accuracy of the replies given by the generative AI is confirmed to be high or errors can be detected in a subsequent test, the generative AI does not have to reply the “other candidate attribute” in S904. In this case, one name candidate is replied by the generative AI for each of the “attribute of information to be registered into cooperation service”. Accordingly, the script generation unit 433 may skip the presentation process to the user in S905, determine the name candidate of each attribute replied by the generative AI as it is as the name of the attribute of information to be registered into the cooperation service, and generate Table 7. Moreover, the number of name candidates of each of the “attribute of information to be registered into cooperation service” replied by the generative AI by using the prompt of FIG. 12 may be more than two.

In S908, the script generation unit 433 determines whether or not the user has reselected the candidate by changing the selected candidate to a candidate other than the name candidate of the attribute that has been selected as a default in the check screen 1300 displayed in S906. In the case where the script generation unit 433 determines that the selected candidate is changed to a candidate other than the name candidate of the attribute that has been selected as a default (YES in S908), the process proceeds to S909. If not (NO in S908), the process proceeds to S911.

For example, assume that the check screen 1300 is displayed in the state where the radio button 1304 for the “date of creation” is selected as a default out of the candidates included in the column 1303 and corresponding to the “date” in a column 1302 in the check screen 1300 as illustrated in FIG. 13. Then, assume that the user changes the check screen 1300 to the state where the radio button 1305 for the “date of payment” is selected, and presses the OK button 1310. In this case, the script generation unit 433 determines that a name indicating a candidate other than the candidate of the name of the attribute that has been selected as a default is reselected, and the process proceeds to S909.

In S909 to S910, the script generation unit 433 performs a process of updating the template of the name candidate reply prompt illustrated in FIG. 12. The update of the template of the name candidate reply prompt is performed to improve the determination accuracy of the generative AI in the case where the generative AI replies the name candidates of the “attribute of each piece of information to be registered into cooperation service” corresponding to each of the names of the “attribute of information extracted by the MFP cooperative service”. The improvement of determination accuracy suppresses the case where the generative AI erroneously replies the name candidate of the attribute to be set to the selected state as a default in S905 of the next operation. Accordingly, it is possible to reduce the work of the user changing the check screen 1300 to the state where the correct candidate is selected.

In S909, the script generation unit 433 performs a process of obtaining additional contents to be added to the template of the name candidate reply prompt used in S905. As a specific process of S909, the script generation unit 433 generates a prompt (referred to as additional content generation prompt) including an instruction for obtaining the additional contents to be added to the template of the name candidate reply prompt. Then, the script generation unit 433 inputs the generated additional content generation prompt into the generative AI, and obtains the additional contents from a reply outputted from the generative AI.

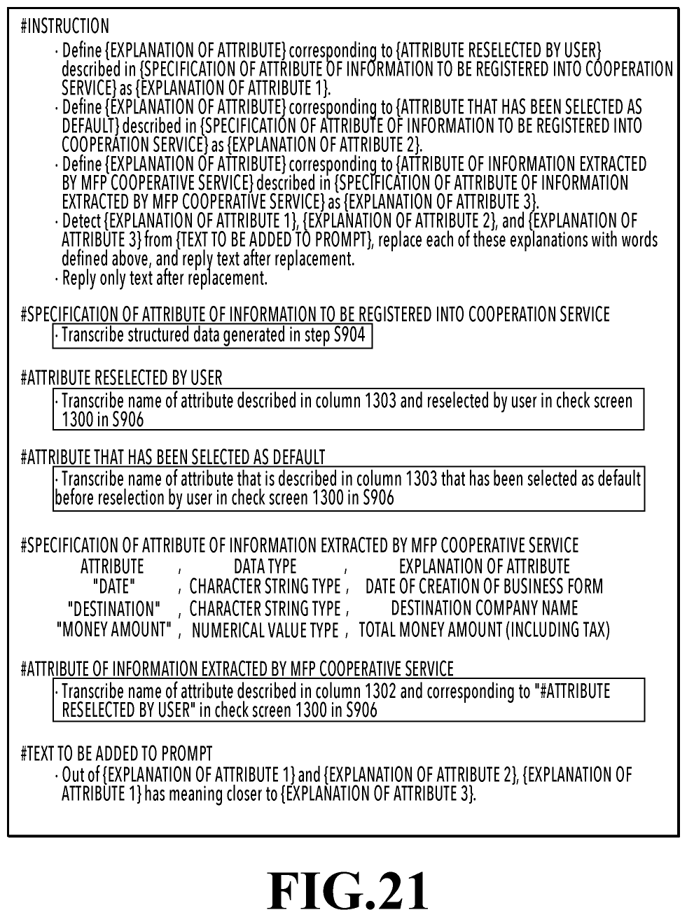

FIG. 21 is a diagram illustrating an example of a template of the additional content generation prompt that is a template for generating the additional content generation prompt. The template of FIG. 21 is stored in, for example, the HDD 314.

As illustrated in FIG. 21, the template of the additional content generation prompt includes a description field for each of items of “specification of attribute of information to be registered into cooperation service”, “attribute reselected by user”, “attribute that has been selected as default”, “specification of attribute of information extracted by MFP cooperative service”, “attribute of information extracted by MFP cooperative service”, and “text to be added to prompt”, in addition to “instruction”. These items are examples of items for causing the generative AI to reply the additional contents, and not all of the items are essential items.

In the template of the additional content generation prompt in FIG. 21, no words or texts are transcribed to fields of “#specification of attribute of information to be registered into cooperation service”, “#attribute reselected by user”, “#attribute that has been selected as default”, and “#attribute of information extracted by MFP cooperative service”. The script generation unit 433 transcribes information to the template of the additional content generation prompt in FIG. 21, and generates the additional content generation prompt.

For example, the script generation unit 433 transcribes the structured data of Table 5 generated in S904 to the field of “#specification of attribute of information to be registered into cooperation service”, transcribes the attribute name reselected by the user out of the names of the attribute displayed as the candidates in the column 1303 of the check screen 1300 displayed in S906, to the field of “#attribute reselected by user”, transcribes the name of attribute that has been selected as a default out of the names of attribute displayed as the candidates in the column 1303 of the check screen 1300 displayed in S906, to the field of “#attribute that has been selected as default”, and transcribes the name of attribute displayed in the column 1302 and corresponding to the “#attribute reselected by user” in the check screen 1300 displayed in S906, to the field of “#attribute of information extracted by MFP cooperative service”. As a result, the additional content generation prompt to be actually inputted into the generative AI is generated.

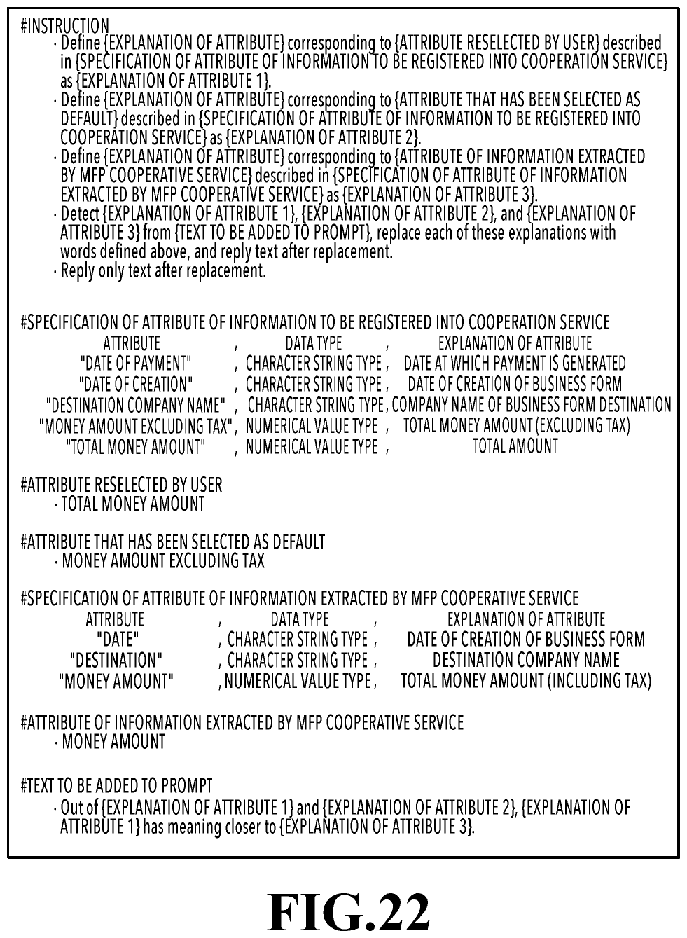

FIG. 22 is a diagram illustrating an example of the additional content generation prompt generated by transcribing the above-mentioned information to the template of the additional content generation prompt in FIG. 21.

For example, assume that, as a result of inputting the name candidate reply prompt into the generative AI in S905, the generative AI erroneously replies the name candidates of the “attribute of information to be registered into cooperation service” corresponding to each of the names of the “attribute of information extracted by MFP cooperative service” as illustrated in Table 8.

TABLE 8

| | Attribute of each piece of | |
|---|---|---|
| Attribute of each piece of | information to be | |
| information extracted by | registered into cooperation | |
| MFP cooperative service | service | Other candidate attribute |
| “Date” | “Date of creation” | “Date of payment” |
| “Destination” | “Destination company | “Issuer company name” |
| | name” | |
| “Money amount” | “Money amount excluding | “Total money amount” |
| | tax” | |

In this case, although not illustrated, the check screen 1300 is displayed in the state where the radio button of “money amount excluding tax” is selected as a default out of the name candidates of the attribute included in the column 1303 and corresponding to the “money amount” in the column 1302 in the check screen 1300. Then, assume that the user switches the selection state to a state where the radio button of “total money amount” included in the column 1303 is selected, and presses the OK button 1310. FIG. 22 illustrates an example of the additional content generation prompt generated in this case.

In FIG. 22, the contents of Table 5 are transcribed to the field of “#specification of attribute of information to be registered into cooperation service” in the template of the additional content generation prompt illustrated in FIG. 21. Moreover, the “total money amount” selected by the user in the check screen 1300 is transcribed to the field of “#attribute reselected by user”. The “money amount excluding tax” that has been selected as a default in the check screen 1300 is transcribed to the field of “#attribute that has been selected as default”. The “money amount” that is the name of the attribute of information extracted by the MFP cooperation service and corresponding to the “total money amount” selected by the user is transcribed to the field of “#attribute of information extracted by MFP cooperative service”.

A text to be added to the template of the name candidate reply prompt used in S905 is outputted by inputting the name candidate reply prompt as illustrated in FIG. 22 into the generative AI. For example, in the case where the name candidate reply prompt of FIG. 22 is inputted into the generative AI, a text indicating additional contents “out of ‘total amount’ and ‘total money amount (tax excluded)’, ‘total amount’ has meaning closer to ‘total money amount (including tax)’” is outputted from the generative AI. The script generation unit 433 can thereby obtain the additional contents to be added to the template.

In S910, the script generation unit 433 adds the additional contents obtained in S909 to the template of the name candidate reply prompt stored in the HDD 314 and illustrated in FIG. 12, and updates the template of the name candidate reply prompt. The script generation unit 433 stores the updated template of the name candidate reply prompt in the HDD 314.

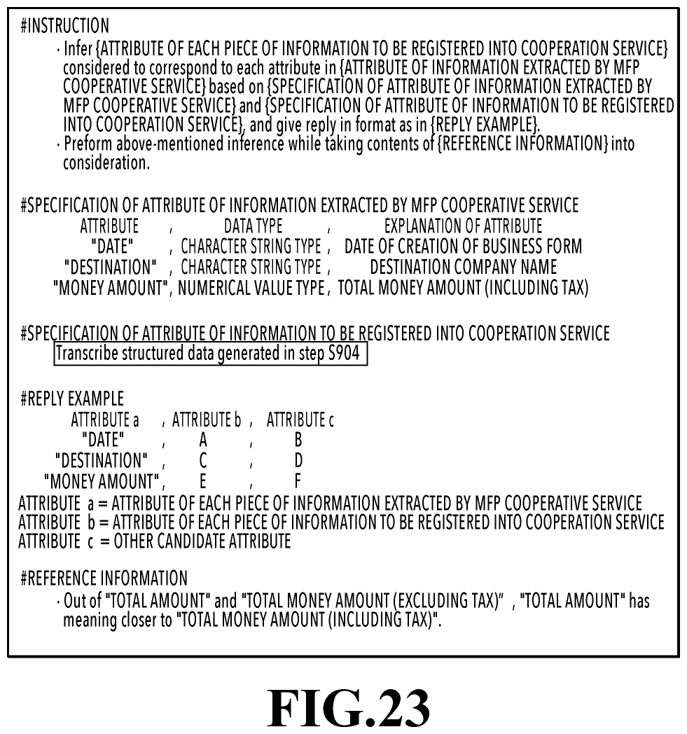

FIG. 23 is a diagram illustrating an example of the template of the name candidate reply prompt updated by adding the additional contents to the template of the name candidate reply prompt in FIG. 12. For example, in comparison of FIG. 12 and FIG. 23, a text of “perform above-mentioned estimation based on contents of {reference information}” is added to the field of “#instruction” in FIG. 23. Moreover, the additional contents obtained in S909 are described in the field of “#reference information”.

Note that the contents to be added to the template of the name candidate reply prompt are not limited to the contents illustrated in FIG. 23. Any text may be added to the template of the name candidate reply prompt in the update process, as long as the generative AI can refer to the additional contents obtained in S909 and perform the process according to these contents.

Reflecting the contents of erroneous determination by the generative AI and the contents of correction by the user in the template of the name candidate reply prompt as described above can suppress occurrence of the same type of erroneous determination in S905 of the next operation.

Note that, in the present embodiment, explanation is given assuming that the additional content generation prompt is executed to obtain the additional contents, and then the additional contents are reflected in the template of the name candidate reply prompt. Alternatively, the configuration may be such that a prompt that causes the generative AI to output a corrected version of the template of the name candidate reply prompt is generated, and the generative AI is made to output a template like that in FIG. 21.

In S911, the script generation unit 433 generates the script as illustrated in FIG. 7 for registering the values into the cooperation service 130, by using the generative AI. As a specific process of S911, first, the script generation unit 433 refers to the specifications for registering information into the cooperation service 130, and generates a prompt for causing the generative AI to reply a script.

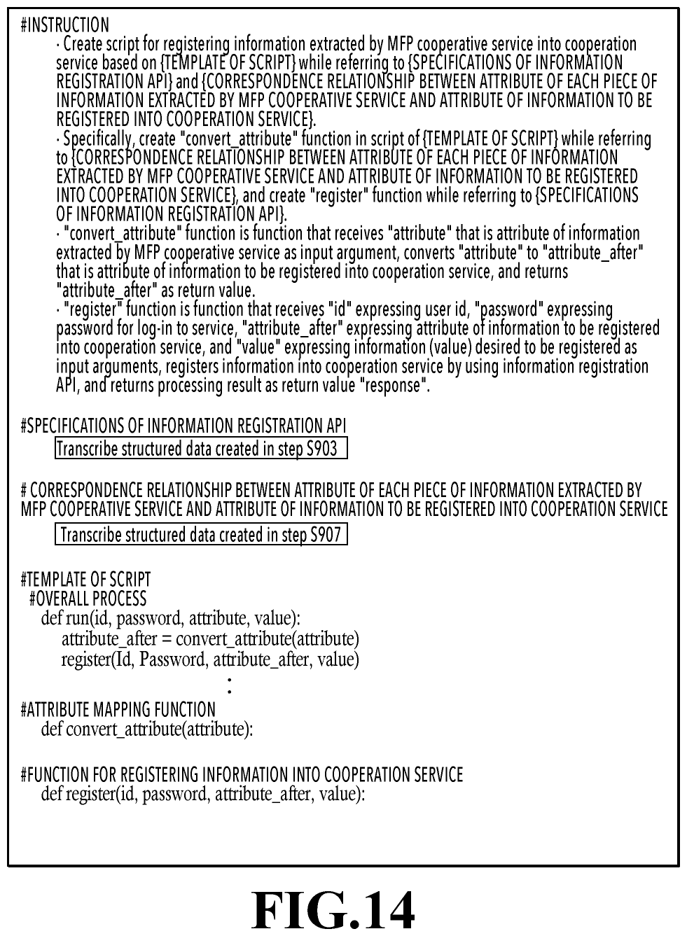

FIG. 14 is a diagram illustrating an example of the prompt for causing the generative AI to reply the script. The prompt of FIG. 14 includes contents of “specifications of information registration API”, “correspondence relationship between attribute of each piece of information extracted by MFP cooperative service and attribute of information to be registered into cooperation service”, and “template of script”, in addition to “instruction”. These items are examples of items for causing the generative AI to give a reply, and not all of the items are essential items.

The prompt of FIG. 14 describes an instruction for completing the script by referring to the contents of “specifications of information registration API” and “correspondence relationship between attribute of each piece of information extracted by MFP cooperative service and attribute of information to be registered into cooperation service”. Accordingly, in the case where the prompt generated by the script generation unit 433 is inputted into the generative AI, there is obtained a script as illustrated in FIG. 7 in which the implementation portions of the convert_attribute function and the register function in the template of the script included in the prompt are described.

A template for generating the prompt as illustrated in FIG. 14 is generated in advance, and stored in the HDD 314. The script generation unit 433 obtains the template corresponding to the prompt of FIG. 14, transcribes the structured data obtained in S903 and the structured data obtained in S907 to the template, and completes the prompt of FIG. 14. The template of FIG. 6 is described in advance in a field of “#template of script” in the template corresponding to the prompt of FIG. 14.

The prompt of FIG. 14 is a prompt that causes the generative AI to generate a script for registering information into the external service provided with the information registration API that also receives designation of the attribute and the value. Specifically, in the case where Table 1 and Table 2 are obtained in S903, a template including the contents of “instruction” and “template of script” in FIG. 14 is obtained. Then, the script generation unit 433 transcribes Table 1 and Table 2 that are the structured data obtained as a result of S903, to the field of “#specifications of information registration API” in the obtained template. Moreover, the script generation unit 433 transcribes Table 7 obtained as a result of S906, to the field of “#correspondence relationship between attribute of each piece of information extracted by MFP cooperative service and attribute of information to be registered into cooperation service”. The prompt of FIG. 14 is thereby generated. An example of the script obtained by inputting, into the generative AI, the prompt of FIG. 14 to which Tables 1, 2, and 7 are transcribed is the script of FIG. 7.

Note that a prompt that causes the generative AI to generate a script for registering information into an external service in which an API is provided for each of the attributes of values to be registered is different from the prompt of FIG. 14. In the case where Table 3 and Table 4 are obtained in S903, in S911, the script generation unit 433 obtains a template corresponding to the prompt for the external service in which the API is provided for each of the attributes of values to be registered, and generates the prompt. In this case, Table 3 and Table 4 that are the structured data obtained as a result of S903 are transcribed to the field of “#specifications of information registration API” in the obtained template. Moreover, contents described in the fields of “#instruction” and “#template of script” in the prompt in this case are different from those in FIG. 14.

Next, the script of FIG. 7 obtained as a result of the process of S911 is explained. In order to register the attributes and the values into an external service such as the expenditure adjustment service, an appropriate name of an attribute registerable by the external service needs to be designated for each value in some cases. The name of the attribute registerable by the external service as described above varies depending on the external service. Moreover, the name of the attribute used in the MFP cooperative service 120 and the name of the attribute registerable by the external service sometimes vary from each other even in the case where these names indicate the same attribute. The convert attribute function is a function that converts the name of the attribute used in the MFP cooperative service 120 such that the value can be registered into the external service.

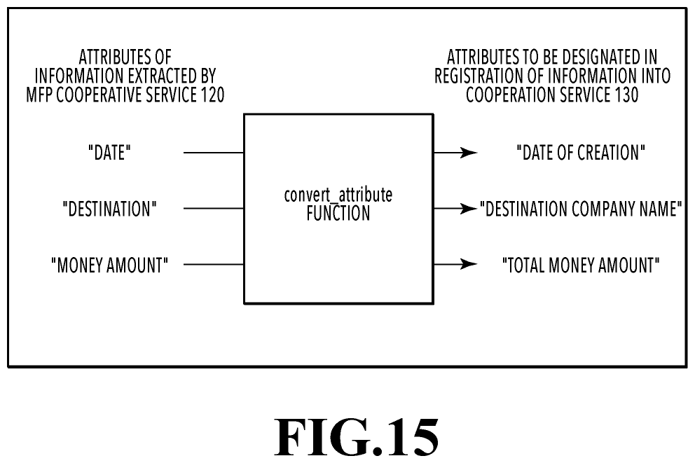

FIG. 15 is a diagram illustrating an example of conversion of the name by the convert attribute function included in the script outputted by inputting, into the generative AI, the prompt of FIG. 14 to which Table 7 is transcribed. The convert_attribute function is a function that maps the names of “attribute of information extracted by MFP cooperative service” to the names of attributes to be registered into the cooperation service 130 based on the correspondence relationship of Table 7. To this end, the generative AI describes the implementation portion of the convert_attribute function such that the name “date” of the attribute of date information in the MFP cooperative service 120 is converted to “date of occurrence”.

The register function is a function that registers information (value) into an external service such as the cooperation service 130. The register function is a function that calls an API made publicly available by the cooperation service 130 to access the cooperation service 130 and register the necessary information in the case where the registration destination of the value is the cooperation service 130. The prompt of FIG. 14 includes an instruction that causes the generative AI to refer to the structured data in which the specifications of the information registration API generated in S903 is organized and describe the implementation portion of the register function such that the above-mentioned process is performed. As a result, in the case where the script of FIG. 7 is executed, “date of occurrence” that is the name of the attribute after the conversion is designated for the attribute of date information, and values that are extracted in the key value extraction process of the MFP cooperative service 120 and that correspond to the date information are registered into the cooperation service 130.

The register function receives the user ID, the password, the attributes of information extracted by the MFP cooperative service 120, and the values desired to be registered as input arguments, and registers the values into the cooperation service 130 while designating the attributes. The value to be designated in the argument “url” in FIG. 7 is information described in the specification document, and is thus described in the script of FIG. 7. The user information that is values to be designated in the argument “id” and the argument “password” is information that varies depending on the user. Accordingly, for example, the client PC 111 accesses the MFP cooperative service 120 via the Internet based on the user operation to cause the user information to be held in the MFP cooperative service 120. Then, in the case where the MFP cooperative service 120 executes the script of FIG. 7, the MFP cooperative service 120 designates the held user information as the value of the argument “id” and the value of the argument “password”. Information extracted by the MFP cooperative service 120 in S809 is designated for the argument “attribute” and the argument “value”.

Note that the script generation unit 433 may directly transcribe the text of the specification document that is not structured to a prompt being an alternative of FIG. 14, and cause the generative AI to generate the script. However, in the case where the structured data in which the specifications for registering information into the external service are organized is described in the prompt as in the prompt of FIG. 14 in the present embodiment, it is possible to make the generative AI generate an intended script with higher accuracy.

### [Test and Correction]

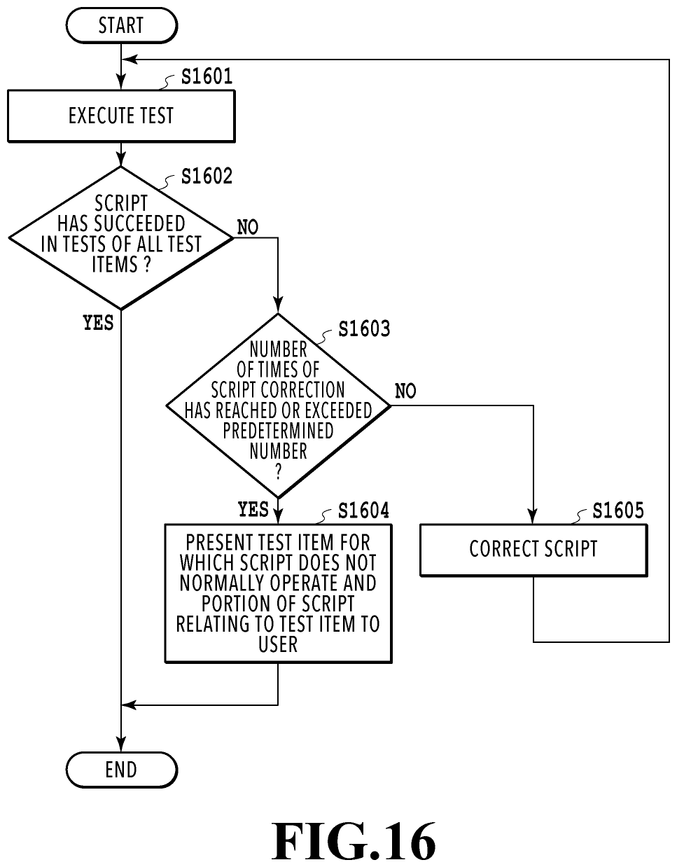

FIG. 16 is a flowchart for explaining a flow of processes in an operation check test for the script generated as a result of executing the flowchart of FIG. 9. The CPU 311 performs a process of each step in the flowchart of FIG. 16 by loading a program code stored in the HDD 314 of the MFP cooperative server 121 onto the RAM 313 and executing the program code. Moreover, part or all of the functions of the steps in FIG. 16 may be implemented by hardware such as an ASIC or an electronic circuit. The flowchart of FIG. 16 is executed, for example, in the case where the MFP cooperative server 121 receives a test execution request from the client PC 111 after completion of the process of S911. Explanation of each step in FIG. 16 is given assuming that the script for registering information into the cooperation service 130 is the script being a test target.

In S1601, the test execution unit 436 executes a test for checking whether the script obtained as a result of the process of S911 operates as expected or not. For example, a test code corresponding to each of external services is assumed to be generated in advance and stored in the HDD 314. In S1601, a test code for the cooperation service 130 corresponding to the script being the test target in the current operation is obtained from among the test codes corresponding to the respective external services stored in the HDD 314. Then, the obtained test code is executed to test whether the script generated by the generative AI in S911 operates as expected. Accordingly, also in the case where a script whose operation is not guaranteed is generated in S911, it is possible to check whether the script operates as expected.

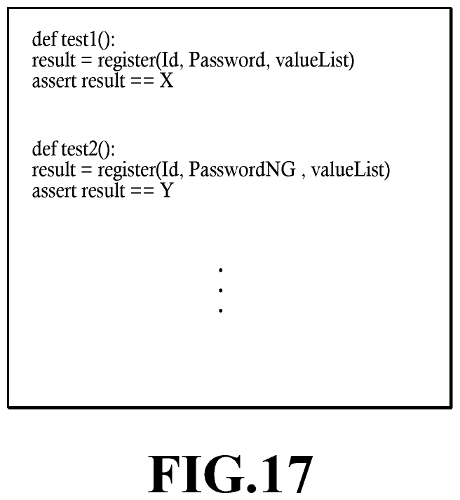

FIG. 17 is a diagram illustrating an example of the test code executed in S1601. Function definitions of each of the functions described in the script being the test target are defined in advance in the specification document of the external service described above, and external specifications of these functions are also fixed. For example, in the case of the script illustrated in FIG. 7, the run function, the convert_attribute function, and the register function correspond to the functions whose function definitions are defined and whose external specifications are also fixed. Accordingly, expected operations of the functions described in the script can be identified by referring to the function definitions and the external specifications in the specification document. Thus, the values to be designated as the arguments and the test code as illustrated in FIG. 17 for checking whether the functions operate as expected can be generated in advance.

In the case where the test code of FIG. 17 is executed, a corresponding portion of the script being the test target in each test item is called, and a test of each test item is executed. For example, the test execution unit 436 determines whether a value (test result) obtained as a result of executing the test of each test item is an expected result described in the test code. In the case where the test result is the expected result, success is outputted for the test item. In the case where the test result is not the expected result, failure is outputted for the test item.

In the present embodiment, explanation is given assuming that the test items include positive testing and negative testing. A test1 function of FIG. 17 is a function for performing the positive testing. A test2 function of FIG. 17 is a function for performing the negative testing.

The positive testing is a test in which correct values are designated as arguments and then whether the information registration into the cooperation service 130 is properly completed or not is checked. Specifically, the test code is generated such that correct values are designated for the user ID, the password, the attributes of information extracted by the MFP cooperative service 120, and the information (values) desired to be registered that are the arguments of test1 in which the positive testing is performed. In other words, in FIG. 17, the test code is generated such that the correct values are designated for the arguments “id”, “Password”, and “valueList”. Then, whether the information registration into the cooperation service 130 is properly completed or not is checked. For example, the test result is a return value obtained in the case where the arguments of test1 are designated as the arguments of the register function in the script being the test target. The expected result is a return value of the register function obtained in the case where the registration is properly completed. In the case where the return value being the test result matches the return value being the expected result, the information registration is completed without trouble. Accordingly, the script is determined to have succeeded in the positive testing.

The negative testing is a test in which incorrect values are designated as arguments and then whether the information registration into the cooperation service 130 fails and an expected error code is sent back or not is checked. Specifically, the test code is generated such that inappropriate values are designated for the user ID, the password, the attributes of information extracted by the MFP cooperative service 120, and the information (values) desired to be registered that are the arguments of test2 in which the negative testing is performed. In FIG. 17, the test code is generated such that an incorrect value is designated for the argument “passwordNG”. Then, whether the information registration into the cooperation service 130 fails and the expected error code is sent back or not is checked. For example, in the negative testing, the test result is a return value obtained in the case where the arguments of test2 are designated as the arguments of the register function in the script being the test target. The expected result is a return value of the register function obtained in the case where the registration fails. In the case where the return value being the test result matches the return value being the expected result, the information registration has failed. Accordingly, the script is determined to have succeeded in the negative testing.

Table 9 is a table in which examples of results of the test process executed in S1601 are summarized. The column of “success or failure of test” holds a value indicating whether the script has succeeded or failed in the test. The column of “expected result” holds an expected result for each test item. For example, since test1 in the column of “test item” is the positive testing, a return value X indicating that the registration is normally performed is held as the expected result. The column of “actual test result” holds a return value obtained by actually performing the test on the script being the test target for each test item. As illustrated in Table 9, in the case where the expected result (expected value) and the actual test result match each other, the script is determined to have succeeded in the test. In the case where the expected result and the actual test result do not match each other, the script is determined to have failed in the test.

TABLE 9

| | Success or failure | | |
|---|---|---|---|
| Test item | of test | Expected result | Actual test result |
| test 1 | success | X | X |
| test 2 | failure | Y | Z |

In S1602, the test execution unit 436 determines whether the script has succeeded in all test items in the test performed in S1601.

In the case where the test execution unit 436 determines that the script has not succeeded in all test items (NO in S1602), the process proceeds to S1603. For example, in the case where the result of performing the test of S1601 is Table 9, the script has not succeeded in the test item of test2, and the test execution unit 436 thus determines that the script has not succeeded in all test items.

In S1603, the test execution unit 436 determines whether the number of times of script correction from start of the present flowchart has reached or exceeded a predetermined number. The script correction is a process performed in S1605 to be described later. In the case where the test execution unit 436 determines that the number of times of script correction is smaller than the predetermined number (NO in S1603), the process proceeds to S1605.

In S1605, the test execution unit 436 causes the generative AI to correct the script being the test target in the current operation such that the script being the test target in the current operation normally operates. In the case where the corrected script corrected by the generative AI is obtained, the process returns to S1601, and the test is performed with the corrected script being set as the script being the test target. As described above, in the operation check test of the present embodiment, the generative AI also performs the process of correcting the script depending on the test result.

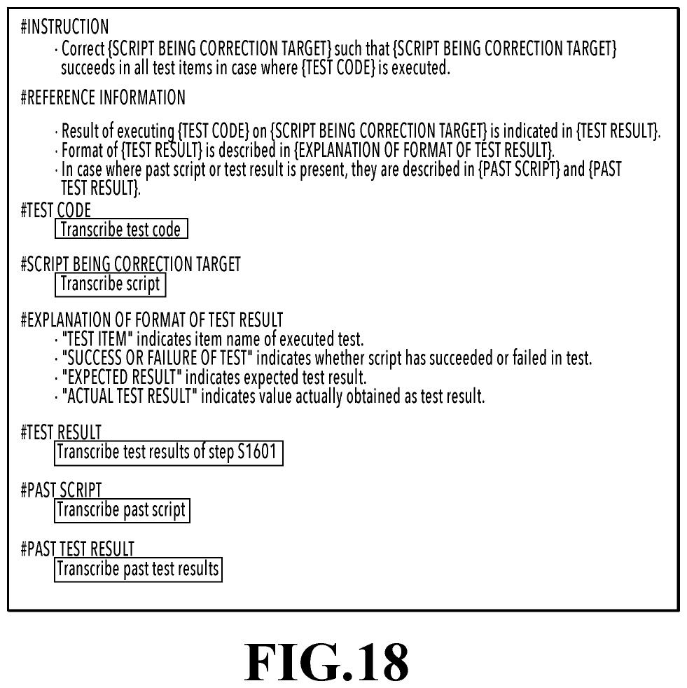

FIG. 18 is a diagram illustrating an example of a prompt to be inputted into the generative AI to correct the script being the test target. In S1605, first, the script generation unit 433 generates a prompt as illustrated in FIG. 18. As illustrated in FIG. 18, the generated prompt includes “reference information”, “test code”, “script being correction target”, “explanation of format of test result”, and “test result”, in addition to “instruction”. These items are examples of items for causing the generative AI to give a reply, and not all of the items are essential items.

A template for generating the prompt of FIG. 18 is generated in advance and stored in the HDD 314. The test execution unit 436 obtains the template corresponding to the prompt of FIG. 18, and transcribes the test code as illustrated in FIG. 17 that is executed in the test of S1601, to a field of “#test code” in the template. The script as illustrated in FIG. 7 that is the test target in S1601 of the current operation is transcribed to a field of “#script being correction target” in the template. The structured data as illustrated in Table 9 that indicates the results of the test process in the test of S1601 of the current operation is transcribed to a field of “#test result” in the template. An instruction to correct the script being the correction target such that the script succeeds in all test items in execution of the test code is described in advance in a field of “#instruction” in the template.

Moreover, in the case where the process has transitioned to S1605 twice or more from the start of the flowchart of FIG. 16 and the correction process has been previously performed in S1605, the script corrected as a result of the previous process of S1605 is transcribed to the field of “#script being correction target”.

Furthermore, in the case where the correction process of the script is the second correction process or beyond, the contents described in the prompt in the previous script correction process may be described in the prompt of the current operation. The generative AI may be made to correct the script while referring to information in the past correction process as described above. For example, the script transcribed to the field of “#script being correction target” in the prompt of past correction may be transcribed to a field of “#past script” as illustrated in FIG. 18. Moreover, the information transcribed to the field of “#test result” in the prompt of past correction may be transcribed to a field of “#past test result”. The past correction is, for example, the previous correction.

Meanwhile, in the case where the test execution unit 436 determines that the number of times of script correction has reached or exceeded the predetermined number in S1603 (YES in S1603), the process proceeds to S1604.

In S1604, the test execution unit 436 causes the generative AI to reply a corresponding portion of the script executed in a test item in which the script is determined to have failed in the test of S1601 in the current operation.

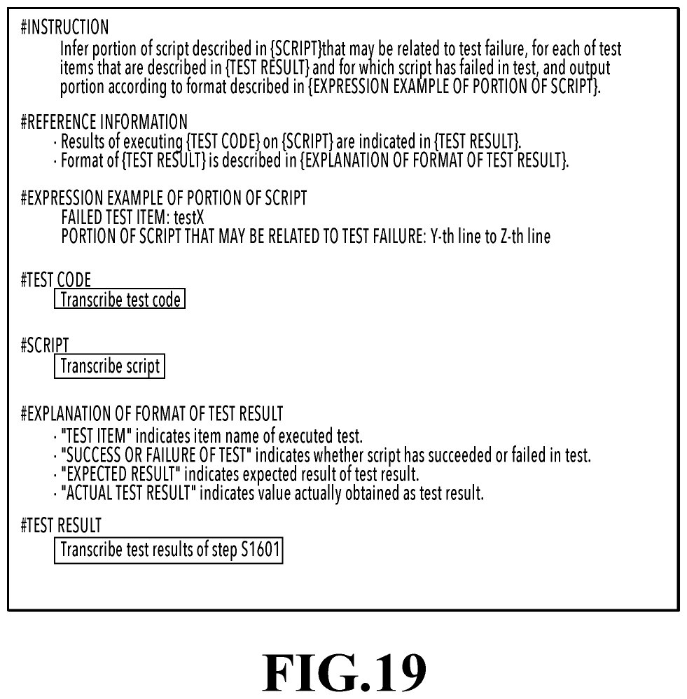

FIG. 19 is a diagram illustrating an example of the prompt for causing the generative AI to reply the corresponding portion of the script executed in the test item in which the script is determined to have failed. In S1604, first, the script generation unit 433 generates a prompt as illustrated in FIG. 19. As illustrated in FIG. 19, the generated prompt includes contents of “reference information”, “expression example of portion of script”, “test code”, “script”, “explanation of format of test result”, and “test result”, in addition to “instruction”. These items are examples of items for causing the generative AI to give a reply, and not all of the items are essential items.

A template for generating the prompt of FIG. 19 is generated in advance and is stored in the HDD 314. The test execution unit 436 obtains the template corresponding to the prompt of FIG. 19, and transcribes the test code as illustrated in FIG. 17 that is executed in the test of S1601, to a field of “#test code” in the template. The script being the test target in the test of S1601 of the current operation is transcribed to a field of “#script” in the template. The structured data as illustrated in Table 9 that indicates the test results in the test of S1601 of the current operation is transcribed to the field of “#test result” in the template.

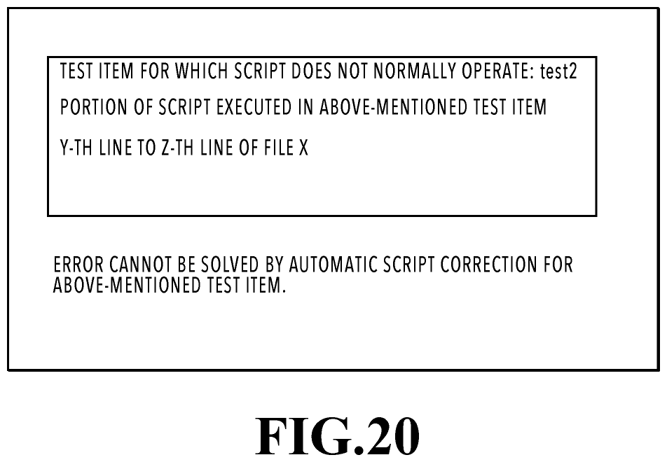

FIG. 20 is a diagram illustrating an example of a notification screen that notifies the user of the reply outputted from the generative AI by inputting the prompt of FIG. 19 into the generative AI. The display control unit 435 sends screen configuration information necessary for display of the notification screen of FIG. 20 to the client PC 111 to allow the user to view the notification screen of FIG. 20. In the notification screen of FIG. 20, there is displayed the test item for which the generative AI has given the reply in response to the input of the prompt of FIG. 19 and for which the test execution unit 436 has determined that the script does not properly operate. Moreover, in the notification screen of FIG. 20, there is displayed the corresponding portion of the script executed in the test item for which the generative AI has given the reply in response to the input of the prompt of FIG. 19 and for which the test execution unit 436 has determined that the script does not properly operate.

Meanwhile, in the case where the test execution unit 436 determines that the script has succeeded in all test items in S1602 (YES in S1602), the flowchart of FIG. 16 is terminated to terminate the test process. The script generation unit 433 outputs the script determined to be successful in all test items to allow the cooperation service access unit 434 to execute the script. For example, the script determined to be successful in all test items is stored in the HDD 314.

Note that, in the case where the accuracy of the script generation by the generative AI is confirmed to be high, the flowchart of FIG. 16 may be omitted. In this case, the script generation unit 433 outputs the script obtained as a result of S911 to allow the cooperation service access unit 434 to execute the script. Moreover, also in the case where the test is performed in another apparatus, the script generation unit 433 may output the script obtained as a result of S911 to the other apparatus.

As explained above, according to the present embodiment, the script for registering information into the external service can be automatically generated by using the generative AI. Accordingly, work load of generating the script can be reduced. Moreover, in the present embodiment, the script can be automatically corrected according to the result of performing the test on the generated script by using the generative AI. Accordingly, it is possible to guarantee that the automatically-generated script operates as expected. Furthermore, since work of correcting the script in the case where a defect is found by the operation check test is reduced, work performed in the case where the test is performed can also be reduced. Moreover, a person who is not skilled in generation or correction of the script can also generate and correct the script. Accordingly, it is possible to reduce load of securing workers in the case where a system cooperation response is to be performed.

### Other Embodiments

Note that explanation is given assuming that the script generated in the above-mentioned embodiment is the script that designates the attributes and registers the attributes and the information (values) corresponding to these attributes into the external service. The script generated in the method of the present embodiment is not limited to the script that registers the attributes and the information corresponding to these attributes into the external service.

According to the technique of the present disclosure, load of generating the script for registering information into the cooperation service can be reduced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-027494—filed Feb. 27, 2024 and Japanese Patent Application No. 2024-206728 filed Nov. 27, 2024, which are hereby incorporated by reference wherein in their entirety.

What is claimed is:

1. An information processing apparatus configured to generate a script for registering, into a cooperation service, information corresponding to a predetermined attribute and extracted from a document image, the information processing apparatus comprising:
a generation unit configured to generate a first prompt for generating a script based on a specification for registering the information into the cooperation service; and
an output unit configured to output the script for registering the information into the cooperation service based on the script generated by a generative AI in response to input of the first prompt.

2. The information processing apparatus according to claim 1, wherein
the generation unit generates the first prompt based on a specification for registering the information into the cooperation service and a specification relating to the predetermined attribute corresponding to the information extracted from the document image by a service for extracting information.

3. The information processing apparatus according to claim 1, wherein
the specification for registering the information into the cooperation service includes a function to be called as an API of the cooperation service, an argument of the function, a return value of the function, explanation of the function, a data type of the argument and the return value, and explanation of the argument and the return value.

4. The information processing apparatus according to claim 1, further comprising
an obtaining unit configured to generate a second prompt including an instruction to generate structured data from a specification document of the cooperation service and obtain the structured data generated by the generative AI in response to input of the second prompt, the structured data being data in which the specification for registering the information into the cooperation service is organized, wherein
the generation unit includes, in the first prompt, the structured data as the specification for registering the information into the cooperation service.

5. The information processing apparatus according to claim 1, wherein
the script outputted from the output unit is a script that causes a first process to be performed in a case where the script is executed,
the first process being a process in which a first name of an attribute used in extracting the information is converted to a second name of an attribute to be designated in registering the information into the cooperation service and the second name and the information are registered into the cooperation service.

6. The information processing apparatus according to claim 5, further comprising
a determination unit configured to generate a third prompt that causes the generative AI to reply a candidate of the second name and determine the second name based on a reply outputted by the generative AI in response to input of the third prompt, wherein
the generation unit generates the first prompt such that the generative AI generates the script in which the first name is converted to the second name determined by the determination unit.

7. The information processing apparatus according to claim 6, wherein
the third prompt includes an instruction for causing the generative AI to reply a plurality of the candidates of the second name,
the information processing apparatus further comprises a display control unit configured to display a check screen in which the plurality of candidates of the second name replied by the generative AI in response to the input of the third prompt are displayed,
the check screen is configured such that one of the plurality of candidates is selected by a user, and
the determination unit determines a character string indicating the candidate selected by the user from the check screen, as the second name.

8. The information processing apparatus according to claim 7, wherein
the third prompt includes an instruction that causes the generative AI to reply a candidate to be set to a selected state as a default in the check screen among the plurality of candidates.

9. The information processing apparatus according to claim 8, further comprising
an update unit configured to update the third prompt in a case where the user selects a target candidate being a candidate other than the candidate that has been selected as a default in the check screen among the plurality of candidates replied by the generative AI in response to the input of the third prompt.

10. The information processing apparatus according to claim 9, wherein
the update unit updates the third prompt such that the generative AI replies the target candidate as the candidate to be set to the selected state as a default in the check screen.

11. The information processing apparatus according to claim 1, further comprising:
a test unit configured to test a script being a test target by executing a test code; and
a correction unit configured to cause the generative AI to correct the script being the test target in a case where the test unit determines that the script being the test target does not operate normally, wherein
the test unit at least performs the test with the script generated by the generative AI in response to the input of the first prompt set as the test target, and
the output unit outputs the script determined to operate normally by the test unit.

12. The information processing apparatus according to claim 11, wherein
the test unit performs the test with the script corrected by the correction unit set as the script being the test target, and
the correction unit does not correct the script being the test target in a case where the number of times of correction already performed by the correction unit is equal to or more than a predetermined number, even if the test unit determines that the script being the test target does not operate normally.

13. The information processing apparatus according to claim 12, further comprising
a display control unit configured to display, in a case where the correction unit does not correct the script being the test target, a notification screen including a portion of the script being the test target executed in a test item for which the test unit has determined that the script does not operate properly.

14. The information processing apparatus according to claim 13, wherein
the portion included in the notification screen is a portion replied by the generative AI in response to input of a fourth prompt that causes the generative AI to reply the portion of the script being the test target.

15. The information processing apparatus according to claim 11, wherein
the correction unit corrects the script being the test target by generating a fifth prompt and obtaining a script corrected by the generative AI in response to input of the fifth prompt, the fifth prompt including an instruction to correct the script being the test target by referring to the test code, the script being the test target, and a result of the test by the test unit.

16. The information processing apparatus according to claim 15, wherein,
in a case where the script being the test target is the script corrected by the correction unit, the correction unit causes the fifth prompt to further include a script being a past test target and a result of a past test.

17. The information processing apparatus according to claim 1, further comprising:
an obtaining unit configured to obtain the document image;
an extraction unit configured to extract the information from the document image; and
a registration unit configured to obtain the script outputted by the output unit, and execute the obtained script to register the information into the cooperation service.

18. The information processing apparatus according to claim 1, wherein
the first prompt includes a template of the script for registering the information into the cooperation service.

19. The information processing apparatus according to claim 1, wherein
the cooperation service is a cloud service relating to expenditure adjustment.

20. An information processing method of generating a script for registering, into a cooperation service, information corresponding to a predetermined attribute and extracted from a document image, the information processing method comprising:
generating a first prompt for generating a script based on a specification for registering the information into the cooperation service; and
outputting the script for registering the information into the cooperation service based on the script generated by a generative AI in response to input of the first prompt.

21. A non-transitory computer readable storage medium storing a program which causes a computer to perform an information processing method of generating a script for registering, into a cooperation service, information corresponding to a predetermined attribute and extracted from a document image, the information processing method comprising:
generating a first prompt for generating a script based on a specification for registering the information into the cooperation service; and
outputting the script for registering the information into the cooperation service based on the script generated by a generative AI in response to input of the first prompt.
